(19) United States
(12) Patent Application Publication
(10) Pub. No.: US 2025/0184078 A1
(43) Pub. Date: Jun. 5, 2025

(54) METHOD AND DEVICE FOR RECEIVING DOWNLINK DATA IN WIRELESS COMMUNICATION SYSTEM

(71) Applicant: Samsung Electronics Co., Ltd., Suwon-si (KR)

(72) Inventors: Deokhui LEE, Suwon-si (KR); Dongmyung KIM, Suwon-si (KR); Donghyeon KIM, Suwon-si (KR); Wonjun KIM, Suwon-si (KR); Hoyoung YOON, Suwon-si (KR); Joohyun PARK, Suwon-si (KR); Junyoung LEE, Suwon-si (KR)

(21) Appl. No.: 18/918,607

(22) Filed: Oct. 17, 2024

(30) Foreign Application Priority Data
Dec. 1, 2023 (KR) 10-2023-0172658

(51) Int. Cl. H04L 5/00

(52) U.S. Cl. CPC H04L 5/0051; H04L 5/0035

(57) ABSTRACT

This disclosure relates to 5th generation (5G) or 6th generation (6G) communication systems to support higher data rates after 4^{th} generation (4G) communication systems such as long-term evolution (LTE). A method performed by a user equipment (UE) in a wireless communication system is provided. The method includes receiving, from each of at least one first transmission/reception point (TRP), a first channel state information reference signal (CSI-RS), receiving, from a second TRP, a second CSI-RS, estimating at least one first phase value of each of the first CSI-RS received from each of the at least one first TRP, based on the first CSI-RS received from each of the at least one first TRP, estimating a second phase value based on the second CSI-RS, and transmitting, to each of the at least one first TRP, a first sounding reference signal (SRS) and a second SRS on different adjacent symbols, respectively, based on a phase shift using the at least one first phase value and the second phase value.

### CROSS-REFERENCE TO RELATED APPLICATION(S)

This application is based on and claims priority under 35 U.S.C. § 119(a) of a Korean patent application number 10-2023-0172658, filed on Dec. 1, 2023, in the Korean Intellectual Property Office, the disclosure of which is incorporated by reference herein in its entirety.

### BACKGROUND

### 1. Field

The disclosure relates to a wireless communication system. More particularly, the disclosure relates to a device and a method for enabling a user equipment (UE) to receive downlink data during coordinated transmission.

### 2. Description of Related Art

Looking back at the evolution of mobile communications over the generations, technologies have been developed primarily for human services such as voice, multimedia, and data. After the commercialization of 5th generation (5G) communication systems, an explosive number of connected devices are expected to be connected to communication networks. Examples of networked objects include vehicles, robots, drones, home appliances, displays, smart sensors installed in various infrastructures, construction machinery, and factory equipment. Mobile devices are expected to evolve into a variety of form factors, including augmented reality glasses, virtual reality headsets, and holographic devices. In the 6th Generation (6G) era, efforts are being made to develop improved 6G communication systems to connect hundreds of billions of devices and objects to provide a variety of services. For this reason, 6G communication systems are often referred to as Beyond 5G systems.

The 6G communication system, which is expected to be realized around 2030, will have a maximum transmission speed of Tera (1000 gigabit) bps (bit per second) and wireless latency of 100 microseconds (μsec), which is 50 times faster than the 5G communication system and one-tenth the wireless latency.

To achieve these high data rates and ultra-low latency, 6G communication systems are being considered for implementation in terahertz bands (e.g., the 95 gigahertz (95 GHz) to 3 terahertz (3 THz) band). The terahertz bands are expected to suffer from more severe path loss and atmospheric absorption compared to the millimeter wave (mmWave) bands introduced in 5G, which will increase the importance of technologies that can ensure signal reach, or coverage. Key technologies to ensure coverage include radio frequency (RF) devices, antennas, new waveforms that are better than orthogonal frequency division multiplexing (OFDM) in terms of coverage, beamforming, and multi-antenna transmission technologies such as massive multiple-input multiple-output (MIMO), full dimensional MIMO (FD-MIMO), array antennas, and large scale antennas. In addition, new technologies such as metamaterial-based lenses and antennas, high-dimensional spatial multiplexing techniques using Orbital Angular Momentum (OAM), and Reconfigurable Intelligent Surfaces (RIS) are being discussed to improve coverage of terahertz band signals.

In addition, to improve frequency efficiency and improve the system network, 6G communication systems will use full duplex technology, which allows uplink (terminal transmission) and downlink (base station transmission) to utilize the same frequency resources at the same time; network technology that integrates satellite and high-altitude platform stations (HAPS); and network structure innovation technology that supports mobile base stations and enables network operation optimization and automation, Dynamic Spectrum Sharing technology, which enables collision avoidance based on spectrum usage forecasts; artificial intelligence (AI)-based communication technology, which utilizes AI from the technology design stage and realizes system optimization by embedding end-to-end AI support functions; and next-generation distributed computing technology, which realizes complex services beyond the limits of terminal computing capabilities by utilizing ultra-high-performance communication and computing resources (multi-access edge computing (MEC), cloud, etc.). In addition, attempts are being made to further enhance the connectivity between devices, further optimize networks, promote the softwarization of network entities, and increase the openness of mobile communications through the design of new protocols to be used in 6G communication systems, the implementation of hardware-based security environments and the development of mechanisms for the secure utilization of data, and the development of technologies on how to maintain privacy.

This research and development of 6G communications systems is expected to enable The Next Hyper-Connected Experience, a new level of hyper-connectivity that includes not only connectivity between things, but also connectivity between people and things. Specifically, services such as Truly Immersive extended reality (XR), High-Fidelity Mobile Hologram, and Digital Replica are expected to be available through the 6G communication system. In addition, services such as Remote Surgery, Industrial Automation, and Emergency Response will be provided through 6G communication systems to enhance security and reliability, and will be applied in various fields such as industrial, medical, automotive, and home appliances.

In particular, due to the short packet arrival times of uplink (UL) extended reality (XR) traffic, the prior art technique of only being able to allocate a UL grant for one hybrid automatic repeat and request (HARQ) process can introduce additional latency when the UL transmission cycle and UL traffic arrival cycle are similar. Various techniques for uplink transmission and retransmission are being considered to address the issues described above and to enable seamless communication between base stations and terminals.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a device and a method capable of performing effective signal transmission/reception in a wireless communication system.

Another aspect of the disclosure is to provide a device and a method for maximizing the gain resulting from downlink data reception during coordinated transmission.

Additional aspects will be set forth in part in the description which follows and, in part, will be apparent from the description, or may be learned by practice of the presented embodiments.

In accordance with an aspect of the disclosure, a method performed by a user equipment (UE) in a wireless communication system is provided. The method includes receiving, from each of at least one first transmission/reception point (TRP), a first channel state information reference signal (CSI-RS), receiving, from a second TRP, a second CSI-RS, estimating at least one first phase value of each of the first CSI-RS received from each of the at least one first TRP, based on the first CSI-RS received from each of the at least one first TRP, estimating a second phase value based on the second CSI-RS, and transmitting, to each of the at least one first TRP, a first sounding reference signal (SRS) and a second SRS on different adjacent symbols, respectively, based on a phase shift using the at least one first phase value and the second phase value.

In accordance with another aspect of the disclosure, a method performed by a first transmission/reception point (TRP) in a wireless communication system is provided. The method includes transmitting, to a user equipment (UE), a first channel state information reference signal (CSI-RS), receiving, from the UE, a first sounding reference signal (SRS) and a second SRS on different adjacent symbols, respectively, based on a phase shift using a first phase value of the first CSI-RS estimated based on the first CSI-RS and a second phase value of a second CSI-RS estimated based on the second CSI-RS of a second TRP, applying a phase compensation between the first TRP and the second TRP using the first SRS and the second SRS received based on the phase shift using the first phase value and the second phase value to a first downlink data, and transmitting, to the UE, the first downlink data to which the phase compensation is applied.

In accordance with another aspect of the disclosure, a user equipment (UE) in a wireless communication system is provided. The UE includes a transceiver, and a controller coupled with the transceiver and configured to receive, from each of at least one first transmission/reception point (TRP), a first channel state information reference signal (CSI-RS), receive, from a second TRP, a second CSI-RS, estimate at least one first phase value of each of the first CSI-RS received from each of the at least one first TRP, based on the first CSI-RS received from each of the at least one first TRP, estimate a second phase value based on the second CSI-RS, and transmit, to each of the at least one first TRP, a first sounding reference signal (SRS) and a second SRS on different adjacent symbols, respectively, based on a phase shift using the at least one first phase value and the second phase value.

In accordance with another aspect of the disclosure, a first transmission/reception point (TRP) in a wireless communication system is provided. The first TRP includes a transceiver, and a controller coupled with the transceiver and configured to transmit, to a user equipment (UE), a first channel state information reference signal (CSI-RS), receive, from the UE, a first sounding reference signal (SRS) and a second SRS on different adjacent symbols, respectively, based on a phase shift using a first phase value of the first CSI-RS estimated based on the first CSI-RS and a second phase value of a second CSI-RS estimated based on the second CSI-RS of a second TRP, apply a phase compensation between the first TRP and the second TRP using the first SRS and the second SRS received based on the phase shift using the first phase value and the second phase value to a first downlink data, and transmit, to the UE, the first downlink data to which the phase compensation is applied.

The disclosure provides a device and a method capable of effectively providing a service in a wireless communication system.

The disclosure provides a device and a method capable of performing effective signal transmission/reception in a wireless communication system.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a wireless environment network in a wireless communication system according to an embodiment of the disclosure;

FIG. 2 illustrates a functional configuration of a base station in a wireless communication system according to an embodiment of the disclosure;

FIG. 3 illustrates a functional configuration of a UE in a wireless communication system according to an embodiment of the disclosure;

FIG. 4 illustrates an example of a radio resource domain in a wireless communication system according to an embodiment of the disclosure;

FIG. 5 illustrates an example of coherent joint transmission (CJT)-based data transmission/reception according to an embodiment of the disclosure;

FIG. 6 illustrates an example for describing a problem that may occur if an inter-phase difference between signals received by a receiving end is fed back based on a codebook, according to an embodiment of the disclosure;

FIG. 7 illustrates an example of a scheme for feeding back an inter-phase difference between signals received by a UE according to an embodiment of the disclosure;

FIG. 8 illustrates an example of a scheme for feeding back an inter-phase difference between signals received by a UE according to an embodiment of the disclosure;

FIG. 9 illustrates an example of CSI-RS resource assignment according to an embodiment of the disclosure;

FIG. 10 illustrates an example of SRS transmission resource assignment according to an embodiment of the disclosure;

FIG. 11 illustrates an example of a scheme for feeding back an inter-phase difference between signals received by a UE according to an embodiment of the disclosure;

FIG. 12 illustrates an example of CSI-RS resource assignment according to an embodiment of the disclosure;

FIG. 13 illustrates an example of SRS transmission resource assignment according to an embodiment of the disclosure;

FIG. 14 illustrates examples of a method for calculating an inter-phase difference according to an embodiment of the disclosure;

FIG. 15 illustrates other examples of a method for calculating an inter-phase difference according to an embodiment of the disclosure;

FIGS. 16 and 17 illustrate an example of a method for determining a validity of a phase difference calculated by a TRP according to various embodiments of the disclosure;

FIG. 18 illustrate an example of a method for determining a validity of a phase difference calculated by a TRP according to an embodiment of the disclosure;

FIG. 19 illustrates an example of a calibrationRSList configuration according to an embodiment of the disclosure;

FIG. 20 illustrates an example of a necessary RRC configuration parameter configuration according to an embodiment of the disclosure;

FIG. 21 illustrates an example in which a feedback scheme for phase calibration between received signals is performed according to an embodiment of the disclosure;

FIG. 22 is a flowchart illustrating an example in which a UE's operating method is performed according to an embodiment of the disclosure; and

FIG. 23 is a flowchart illustrating an example in which a TRP's operating method is performed according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Hereinafter, various embodiments of the disclosure will be described based on an approach of hardware. However, various embodiments of the disclosure include a technology that uses both hardware and software, and thus the various embodiments of the disclosure may not exclude the perspective of software. In addition, terms referring to network entities, terms referring to device elements, and the like are illustratively used for the sake of descriptive convenience. Therefore, the disclosure is not limited by the terms as described below, and other terms referring to subjects having equivalent technical meanings may be used.

Furthermore, various embodiments of the disclosure will be described using terms employed in some communication standards (e.g., the 3rd generation partnership project (3GPP) and European telecommunication standards institute (ETSI)), but they are for illustrative purposes only. Various embodiments of the disclosure may be easily applied to other communication systems through modifications.

Moreover, in the disclosure, the expression “greater than” or “less than” is used to determine whether a specific condition is satisfied or fulfilled, but this is intended only to illustrate an example and does not exclude “greater than or equal to” or “equal to or less than”. A condition indicated by the expression “greater than or equal to” may be replaced with a condition indicated by “greater than”, a condition indicated by the expression “equal to or less than” may be replaced with a condition indicated by “less than”, and a condition indicated by “greater than and equal to or less than” may be replaced with a condition indicated by “greater than and less than”.

In the following description, terms referring to signals, terms referring to channels, terms referring to control information, terms referring to network entities, terms referring to device elements, and the like are illustratively used for the sake of descriptive convenience. Therefore, the disclosure is not limited by the terms as described below, and other terms referring to subjects having equivalent technical meanings may be used.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

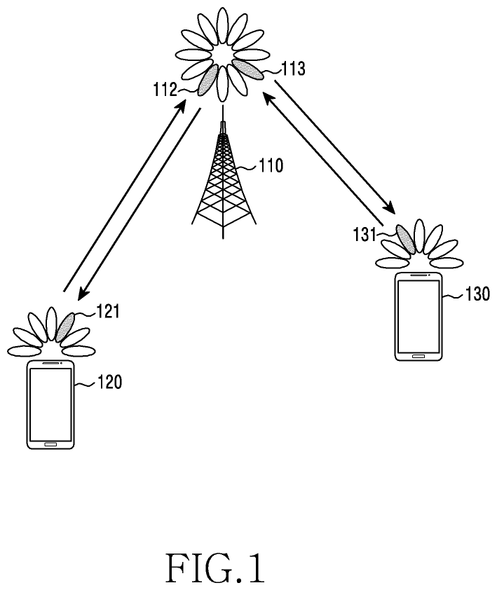

FIG. 1 illustrates a wireless environment network in a wireless communication system according to an embodiment of the disclosure.

Referring to FIG. 1, an example of a base station 110, a first UE 120, and a second UE 130 as a part of nodes that use radio channels in a wireless communication system is illustrated. Although FIG. 1 illustrates only one base station, base stations identical or similar to the base station 110 may be further included.

The base station 110 is a network infrastructure configured to provide wireless connection to the UEs 120 and 130. The base station 110 has a coverage which is defined as a predetermined geographical region based on the distance to which signals may be transmitted. The base station 110 may be also be referred to as “access point (AP)”, “eNodeB (eNB)”, “5th generation node (5G node)”, “next generation nodeB (gNB)”, “wireless point”, “transmission/reception point (TRP)”, or other terms having equivalent technical meanings, in addition to “base station”.

Each of the first UE 120 and the second UE 130 refers to a device used by a user to perform communication with the base station 110 through a radio channel. In some cases, at least one of the first UE 120 and the second UE 130 may be operated without the user's intervention. That is, at least one of the first UE 120 and the second UE 130 may be a device configured to perform machine type communication (MTC) without being carried by the user. Each of the first UE 120 and the second UE 130 may also referred to as “terminal”, “mobile station”, “subscriber station”, “remote terminal”, “wireless terminal”, “user device”, or other terms having equivalent technical meanings, in addition to “user equipment (UE)”.

The base station 110, the first UE 120, and the second UE 130 may transmit and receive radio signals in mmWave bands (e.g., 28 GHz, 30 GHz, 38 GHz, and 60 GHz). The base station 110, the first UE 120, and the second UE 130 may perform beamforming to improve channel gain. Beamforming, as used herein, may include transmission beamforming and reception beamforming. That is, the base station 110, the first UE 120, and the second UE 130 may assign directivity to transmitted or received signals. To this end, the base station 110 and the UEs 120 and 130 may select serving beams 112, 113, 121 and 131 through a beam search or beam management procedure. After the serving beams are selected, subsequent communication may be performed through resources having a quasi co-located (QCL) relation with resources used to transmit the serving beams.

If large-scale characteristics of a channel used to transfer a symbol on a first antenna port may be inferred from a channel used to transfer a symbol on a second antenna port, the first and second antenna ports may be assessed as having a QCL relation. For example, the large-scale characteristics includes at least one of delay spread, Doppler spread, Doppler shift, average gain, average delay, and spatial receiver parameter.

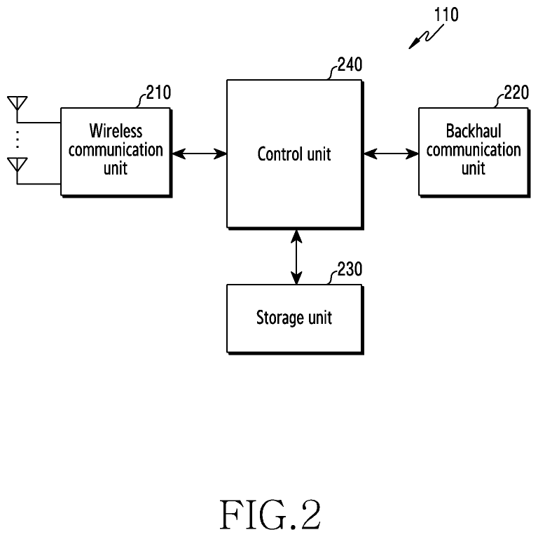

FIG. 2 illustrates the functional configuration of a base station in a wireless communication system according to an embodiment of the disclosure. The configuration illustrated in FIG. 2 may be understood as the configuration of the base station 110. As used herein, terms such as “unit” and “-er” refer to units configured to process at least one function or operation, and may be implemented as hardware, software, or a combination of hardware and software.

Referring to FIG. 2, the base station includes a wireless communication unit 210, a backhaul communication unit 220, a storage unit 230, and a control unit 240.

The wireless communication unit 210 performs functions for transmitting/receiving signals through a radio channel. For example, the wireless communication unit 210 performs a function for conversion between a baseband signal and a bitstring according to the physical layer specification of the system. For example, during data transmission, the wireless communication unit 210 encodes and modulates a transmitted bitstring, thereby generating complex symbols. In addition, during data reception, the wireless communication unit 210 demodulates and decodes a baseband signal, thereby restoring a received bitstring.

In addition, the wireless communication unit 210 up-converts a baseband signal to a radio frequency (RF) band signal, transmits the same through an antenna, and down-converts an RF band signal received through the antenna to a baseband signal. To this end, the wireless communication unit 210 may include a transmission filter, a reception filter, an amplifier, a mixer, an oscillator, a digital-to-analog (DAC) converter, an analog-to-digital (ADC) converter, and the like. In addition, the wireless communication unit 210 may include multiple transmission/reception paths. Furthermore, the wireless communication unit 210 may include at least one antenna array including multiple antenna elements.

In terms of hardware, the wireless communication unit 210 may include a digital unit and an analog unit. The analog unit may include multiple sub-units according to the operating power, operating frequency, and the like. The digital unit may be implemented as at least one processor (e.g., digital signal processor (DSP)).

The wireless communication unit 210 transmits and receives signal as described above. Accordingly, all or part of the wireless communication unit 210 may be referred to as “transmitter”, “receiver”, or “transceiver”. In addition, transmission and reception performed through a radio channel, as will be described hereinafter, will be used in a sense including the above-described processing performed by the wireless communication unit 210.

The backhaul communication unit 220 provides an interface for performing communication with other nodes inside the network. That is, the backhaul communication unit 220 converts bitstrings transmitted from the base station to other nodes, for example, other access nodes, other base stations, upper-level nodes, core networks, and the like, to physical signals and converts physical signals received from other nodes to bitstrings.

The storage unit 230 stores data such as default programs for operations of the base station, application programs, configuration information, and the like. The storage unit 230 may be configured as a volatile memory, a nonvolatile memory, or a combination of a volatile memory and a nonvolatile memory. The storage unit 230 also provides stored data at the request of the control unit 240.

The control unit 240 (or controller) controls overall operations of the base station. For example, the control unit 240 transmits and receives signals through the wireless communication unit 210 or the backhaul communication unit 220. In addition, the control unit 240 records data in the storage unit 230 and reads the same. The control unit 240 may also perform functions of a protocol stack required by communication specifications. According to another example of implementation, the protocol stack may be included in the wireless communication unit 210. To this end, the control unit 240 may include at least one processor.

According to various embodiments, the control unit 240 may control the base station so as to perform operations according to various embodiments described later.

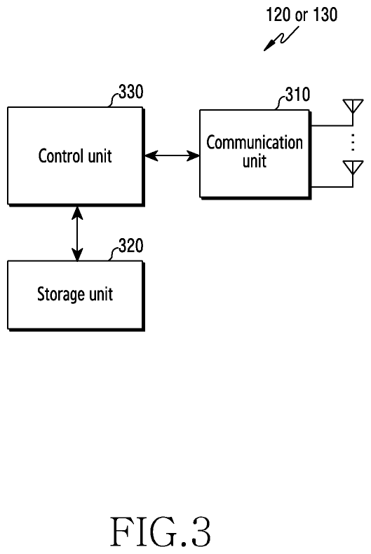

FIG. 3 illustrates the functional configuration of a UE in a wireless communication system according to an embodiment of the disclosure. The configuration illustrated in FIG. 3 may be understood as the configuration of a UE 120 or 130. As used herein, terms such as “unit” and “-er” refer to units configured to process at least one function or operation, and may be implemented as hardware, software, or a combination of hardware and software.

Referring to FIG. 3, the UE includes a communication unit 310, a storage unit 320, and a control unit 330.

The communication unit 310 performs functions for transmitting/receiving signals through a radio channel. For example, the communication unit 310 performs a function for conversion between a baseband signal and a bitstring according to the physical layer specification of the system. For example, during data transmission, the communication unit 310 encodes and modulates a transmitted bitstring, thereby generating complex symbols. In addition, during data reception, the communication unit 310 demodulates and decodes a baseband signal, thereby restoring a received bitstring. In addition, the communication unit 310 up-converts a baseband signal to an RF band signal, transmits the same through an antenna, and down-converts an RF band signal received through the antenna to a baseband signal. For example, the communication unit 310 includes a transmission filter, a reception filter, an amplifier, a mixer, an oscillator, a DAC, an ADC, and the like.

In addition, the communication unit 310 include multiple transmission/reception paths. Furthermore, the communication unit 310 may include at least one antenna array including multiple antenna elements. In terms of hardware, the communication unit 310 may include a digital circuit and an analog circuit (e.g., a radio frequency integrated circuit (RFIC)). The digital circuit and the analog circuit may be implemented as a single package. In addition, the communication unit 310 may include multiple RF chains. Furthermore, the communication unit 310 may perform beamforming.

The communication unit 310 transmits and receives signal as described above. Accordingly, all or part of the communication unit 310 may be referred to as “transmitter”, “receiver”, or “transceiver”. In addition, transmission and reception performed through a radio channel, as will be described hereinafter, will be used in a sense including the above-described processing performed by the communication unit 310.

The storage unit 320 stores data such as default programs for operations of the UE, application programs, configuration information, and the like. The storage unit 320 may be configured as a volatile memory, a nonvolatile memory, or a combination of a volatile memory and a nonvolatile memory. The storage unit 320 also provides stored data at the request of the control unit 330.

The control unit 330 (or controller) controls overall operations of the UE. For example, the control unit 330 transmits and receives signals through the communication unit 310. In addition, the control unit 330 records data in the storage unit 320 and reads the same. The control unit 330 may also perform functions of a protocol stack required by communication specifications. To this end, the control unit 330 may include at least one processor or microprocessor, or may be a part of the processor. In addition, a part of the communication unit 310 and the control unit 330 may be referred to as a communication processor (CP).

According to various embodiments, the control unit 330 may control the UE so as to perform operations according to various embodiments described later.

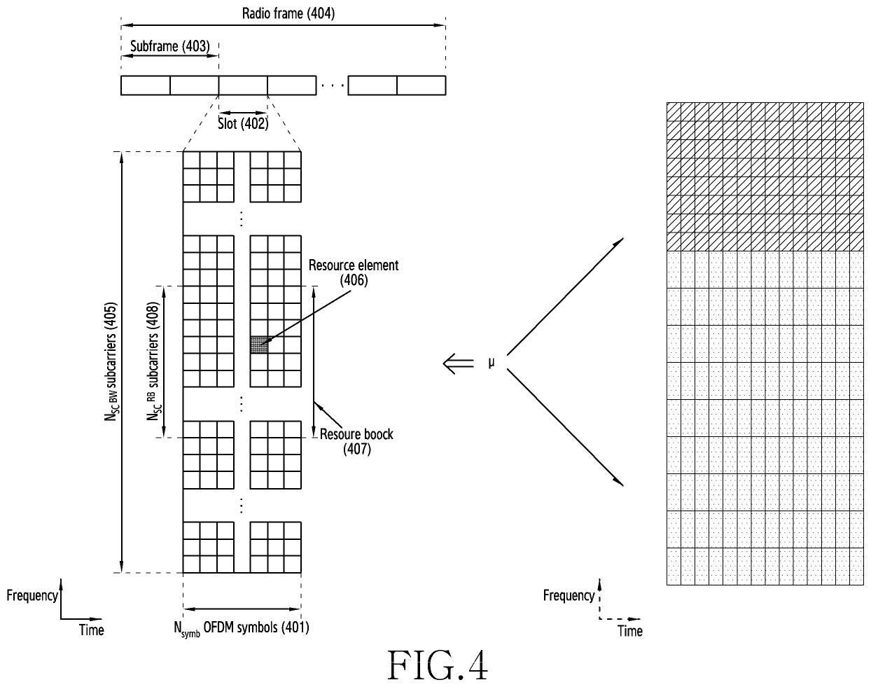

FIG. 4 illustrates an example of a radio resource domain in a wireless communication system according to an embodiment of the disclosure. In various embodiments of the disclosure, the radio resource domain may include the structure of a time-frequency domain. According to an embodiment, the wireless communication system may include a new radio (NR) communication system.

Referring to FIG. 4, the horizontal axis in the radio resource domain denotes the time domain, and the vertical axis denotes the frequency domain. The radio frame 404 has a length of 10 ms. The radio frame 404 may be a time domain section including ten subframes. The subframes 403 have a length of 1 ms. The unit of configuration in the time domain may be orthogonal frequency division multiplexing (OFDM) and/or discrete Fourier transform (DFT)-spread-OFDM (DFT-s-OFDM) symbols, and a group of N_{symb} OFDM and/or DFT-s-OFDM symbols 401 may constitute one slot 402. According to various embodiments of the disclosure, OFDM symbols may include symbols related to a case in which signals are transmitted/received by using an OFDM multiplexing scheme, and DFT-s-OFDM symbols may include symbols related to a case in which signals are transmitted/received by using a DFT-s-OFDM or single carrier frequency division multiple access (SC-FDMA) multiplexing scheme. The smallest unit of transmission in the frequency domain is a subcarrier, and a total of N_{scBW} subcarriers 405 may constitute a carrier bandwidth that constitutes a resource grid. In addition, although an embodiment regarding downlink signal transmission/reception will be described in the disclosure for convenience of description, the same is also applicable to an embodiment regarding uplink signal transmission/reception.

According to an embodiment, the number of slots 402 constituting one subframe 403 and the length of slots 402 may differ according to a subcarrier spacing. Such a subcarrier spacing may be referred to as numerology p. For example, the subcarrier spacing, the number of slots included in a subframe, the length of slots, and the length of subframes may be variably configured. For example, if the subcarrier spacing (SCS) in an NR communication system is 15 kilohertz (kHz), one slot 402 constitutes one subframe 403, and each of the slot 402 and the subframe 403 have a length of 1 ms. In addition, for example, if the subcarrier spacing is 30 kHz, two slots may constitute one subframe 403. The slots have a length of 0.5 ms, and the subframe has a length of 1 ms.

According to an embodiment, the subcarrier spacing, the number of slots included in a subframe, the length of slots, and the length of subframes may be variably applied according to the communication system. For example, in the case of a long-term evolution (LTE) system, the subcarrier spacing is 15 kHz, and two slots constitute one subframe. In this case, the slots may have a length of 0.5 ms, and the subframe may have a length of 1 ms. As another example, in the case of an NR system, the subcarrier spacing (μ) may be one of 15 kHz, 30 kHz, 60 kHz, 120 kHz, 240 kHz, 480 kHz, and 960 kHz, and the number of slots included in one subframe may be 1, 2, 4, 8, 16, 32, or 64, depending on the subcarrier spacing (μ).

The basic unit of resources in the time-frequency domain may be a resource element (RE) 406, which may be expressed by an OFDM symbol index and a subcarrier index. A resource block may include multiple resource elements. In an NR system, a resource block (RB) (or physical resource block (PRB)) 407 may be defined as N_{SC}^{RB} consecutive subcarriers 408 in the frequency domain. The number of subcarriers may be N_{SC}^{RB}=12. The frequency domain may include common resource blocks (CRBs). A PRB may be defined in a bandwidth part (BWP) in the frequency domain. The CRB and PRB numbers may be determined differently according to the subcarrier spacing. In an LTE system, an RB may be defined by N_{symb} consecutive OFDM symbols in the time domain and N_{SC}^{RB} consecutive subcarriers in the frequency domain.

In NR and/or LTE systems, scheduling information regarding downlink data or uplink data may be transferred from the base station 110 to the UE 120 through downlink control information (DCI). According to various embodiments of the disclosure, DCI may be defined according to various formats, and each format may indicate whether the DCI includes scheduling information (e.g., UL grant) regarding uplink data, whether the DCI includes scheduling information (e.g., DL resource allocation) regarding downlink data, whether the DCI is compact DCI having a small control information size or fallback DCI, whether spatial multiplexing that uses multiple antennas is applied, and/or whether the DCI is for power control. For example, NR DCI format 1_0 or NR DCI format 1_1 includes scheduling regarding downlink data. In addition, for example, NR DCI format 0_0 or NR DCI format 0_1 includes scheduling regarding uplink data.

As described above, FIG. 4 illustrates an example of downlink and uplink slot structures in a wireless communication system. Particularly, FIG. 4 illustrates the structure of a resource grid of an NR system. Referring to FIG. 4, a slot may include multiple orthogonal frequency division multiplexing (OFDM) symbols in the time domain, and may include multiple resource blocks (RBs) in the frequency domain. A signal may include a part or all of a resource grid. In addition, the number of OFDM symbols included in one slot may vary depending on the length of a cyclic prefix (CP). Although FIG. 4 illustrates a case in which one slot includes 14 OFDM symbols for convenience of description, the configuration of symbols is not specified in connection with a signal referred to in the disclosure. Furthermore, the scheme in which a generated signal is modulated is not specified to quadrature amplitude modulation (QAM) of a specific value, and modulation schemes of various communication specifications, such as binary phase-shift keying (BPSK) and quadrature phase shift keying (QPSK), may be followed.

According to various embodiments of the disclosure, operations for controlling uplink retransmission for efficient signal transmission will be described based on an LTE communication system or NR communication system, but the content of the disclosure is not limited thereto, and may be applied to various wireless communication systems for transmitting downlink or uplink control information. In addition, it is obvious that the content of the disclosure may be applied not only to a licensed band, but also to an unlicensed band, if necessary.

Hereinafter, higher layer signaling or higher signal, as used herein, may correspond to a signal transfer method in which the base station 110 transfers signals to the UE 120 by using a physical layer downlink data channel, or the UE 120 transfers signals to the base station 110 by using a physical layer uplink data channel. According to an embodiment, higher layer signaling may include at least one of radio resource control (RRC) signaling, or signaling according to an F1 interface between a centralized unit (CU) and a distributed unit (DU), or a signal transfer method in which signals are transferred through a medium access control (MAC) control element (MAC CE). In addition, according to an embodiment, higher layer signaling or higher signal may include system information (e.g., system information block (SIB)) commonly transmitted to multiple UEs 120.

In a 5G wireless communication system, a synchronization signal block (SSB) (also referred to as SS block, SS/PBCH block, or the like) may be transmitted for initial access, and the synchronization signal block may include a primary synchronization signal (PSS), a secondary synchronization signal (SSS), and physical broadcast channel (PBCH). In addition, the SSB may include information regarding a beam used by the base station to transmit signals, and an SSB index or SSB, as used herein, may refer to at least one beam. In the initial access step in which a UE initially accesses a system, the UE may acquire downlink time and frequency domain synchronization from a synchronization signal through a cell search procedure, and may acquire a cell ID. The synchronization signal may include a PSS and an SSS. The UE may receive a PCBH including a master information block (MIB) from the base station, thereby acquiring system information regarding transmission/reception, such as a system bandwidth or related control information, and basic parameter values. The UE may perform decoding with regard to a physical downlink control channel (PDCCH) and a physical downlink shared channel (PDSCH), based on the received PBCH, thereby acquiring a system information block (SIB). The UE may then exchange identity with the base station through a random access step, and may initially access a network through steps of registration, authentication, and the like.

As described above, one slot may include 14 symbols. According to various embodiments of the disclosure, uplink-downlink configuration of symbols and/or slots may be configured in three steps in a 5G communication system.

In the first method, uplink-downlink configuration of symbols and/or slots may be configured semi-statically through cell-specific configuration information based on symbol-level system information. More specifically, cell-specific uplink-downlink configuration information through system information may include uplink-downlink pattern information and subcarrier information that serves as a reference. The uplink-downlink pattern information may indicate periodicity, the number of consecutive downlink slots from the starting point of each pattern, the number of symbols of the next slot, the number of consecutive uplink slots from the end of a pattern, and the number of symbols of the next slot. Slots and symbols which are not indicated with the uplink and downlink may be deemed to be flexible slots/symbols.

In the second method, through user-specific configuration information based on dedicated higher layer signaling, flexible slots or slots including flexible symbols may be indicated with the number of consecutive downlink symbols from the starting symbol of each slot and with the number of consecutive uplink symbols from the end of the slot, or may be indicated with the entire downlink of the slot or the entire uplink of the slot.

In the third method, in order to dynamically change downlink signal transmission and uplink signal transmission sections, symbols indicated as flexible symbols in each slot (e.g., symbols not indicated with the downlink and uplink) may be indicated whether each is a downlink symbol or uplink symbol or flexible symbol through a slot format indicator (SFI) included in the downlink control channel. The slot format indicator may select one index from a table in which the uplink/downlink configuration of 14 symbols in one slot is preconfigured.

In 5G NR, coherent joint transmission (CJT) and non-coherent joint transmission (NCJT) may be defined for DL/UL reception/transmission from/to the UE's multi-transmission reception point (TRP).

The CJT in 5G NR is one of core technologies capable of improving the throughput of 5G NR, and a technology named coordinated multi-point (CoMP) has been known in 4G LTE. In the case of CJT, each TRP transmits the same data to the receiving end, the receiving end (e.g., UE) overlaps and receives modulation signals regarding data transmitted by each TRP, and the receiving end may improve the SINR performance through the same, thereby improving the reception performance.

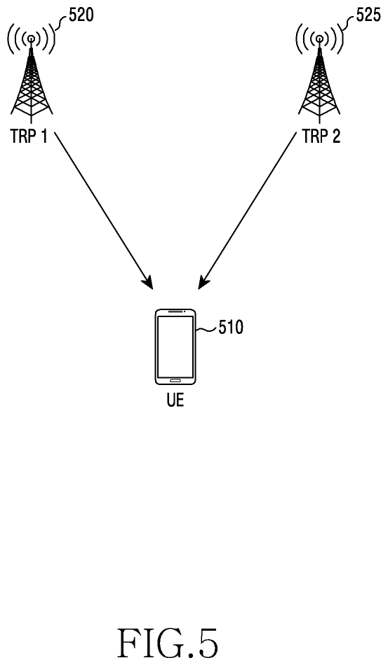

FIG. 5 illustrates an example of CJT-based data transmission/reception according to an embodiment of the disclosure.

Referring to FIG. 5, TRP 1 520 and TRP 2 525 may transmit the same data to the UE 510, and the UE 510 may overlap and receive modulated signals regarding the same data transmitted from TRP 1 520 and TRP 2 525. Signals received by the UE 510 may be expressed as in the following equation:

$$\begin{matrix}y = HWx + n \\ H = [ H 1 H 2 ] \\ W = f ( H ) = [ \begin{matrix}W 1 \\ W 2\end{matrix} ]\end{matrix} \qquad Equation 1$$

In the above equation, H1 refers to a channel matrix from TRP 1 520 to the UE 510 in FIG. 5, and H2 refers to a channel matrix from TRP 2 525 to the UE 510. In addition, W refers to a precoding matrix used by TRP 1 520 and TRP 2 525 to transmit downlink signals to the UE 510.

In the case of CJT, when the receiving end receives signals transmitted from respective TRPs, the performance gain through the CJT may be maximized by removing the inter-phase difference between signals received by the receiving end. Therefore, it may be an important requirement in the case of the CJT that there be no inter-phase difference between signals received by the receiving end. However, the inter-phase difference may occur in actual systems for the following reasons:
(1) During a CJT operation, respective TRPs may use different local oscillators
(2) During a CJT operation, antenna modules of respective TRPs may have different phase drift values
(3) During a CJT operation, the propagation delay until signals transmitted from respective TRPs reach the receiving end may differ with each other

As such, in order to compensate for the inter-phase difference between signals received by the receiving end, which may occur in actual CJT systems, phase calibration (or phase compensation) may be needed.

Trends regarding specifications related to technologies for compensating for the inter-phase difference between signals received by the receiving end, which may occur in CJT systems, will now be briefly described. There has been no method for enabling the receiving end to report the inter-phase difference between signals received by the receiving end until Rel. 17. Instead, there has solely been feedback information which indicates a phase difference, based on 90° granularity between CSI-RS ports with regard to an n-port CSI-RS (n>1).

Meanwhile, in Rel. 18, there has been ongoing discussion regarding a scheme for designing a codebook for CJT, but there has been no consideration of a scheme for directly feeding back the inter-phase difference between signals received by the receiving end. Instead, focus has been placed on designing a precoding matrix capable of maximizing the performance in consideration of the inter-phase difference between signals received by the receiving end.

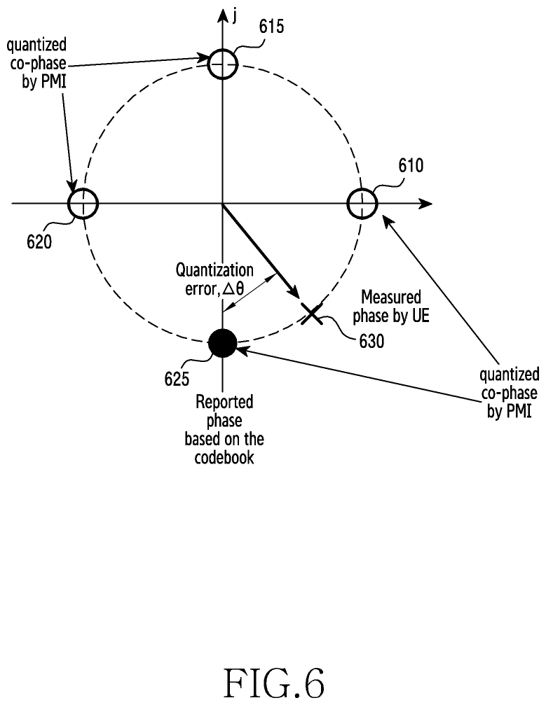

Various schemes may be considered as a method for feeding back the inter-phase difference between signals received by the receiving end in CJT, but there may be a number of limitations if a codebook-based feedback scheme is considered (that is, if a quantized inter-phase difference is fed back). One of the limitations will now be described with reference to FIG. 6.

FIG. 6 illustrates an example for describing a problem that may occur if the inter-phase difference between signals received by the receiving end is fed back based on a codebook according to an embodiment of the disclosure.

Referring to FIG. 6, an example of a quantization error that may occur if the inter-phase difference is quantized and expressed by using two bits is illustrated. FIG. 6 illustrates a complex plane, the x axis of which corresponds to real axis, and the y axis of which corresponds to the imaginary axis. Phase values which may represent the inter-phase difference between received signals as a quantized value by using two bits may correspond to 0 (0, rad) 610, j (/2, rad) 615, −1 (π, rad) 620, −j (3π/2, rad) 625 on the complex plane. The inter-phase difference between received signals, measured by the UE, may be as indicated by 630 in FIG. 6. During codebook-based inter-phase difference value feedback, the receiving end has to report −j (3π/2, rad) 625, which is closest to the inter-phase difference value 630, and a quantization error may thus occur. In order to reduce such quantization errors, the inter-phase difference between received signals needs to be expressed as a quantized value by using a larger number of bits (more than two bits). However, the overhead for feedback may be increased by using a larger number of bits for feedback. Therefore, referring to FIG. 6, there may be a trade-off between the feedback overhead used to feed back the inter-phase difference and quantization errors.

Next, when the inter-phase difference between signals received by the receiving end is fed back based on a codebook, the inter-phase difference in respective PRBs, which are measurement targets for feedback, may not be uniform. More specifically, if a codebook-based feedback method is used, an inter-phase difference value between signals received by the receiving end may be commonly applied to all PRBs (wideband report method), and an inter-phase difference value between received signals may be commonly applied to each group of predetermined number of PRBs (sub-band report method). The wideband report method and the sub-band report method may have the following limitations, respectively:
(1) In the case of wideband reporting, the inter-phase difference value between received signals, which is commonly applied to all PRBs, may not be a suitable value in the case of a specific PRB.
(2) In the case of sub-band reporting, a separate inter-phase difference value is fed back with regard to each sub-band, and the overall feedback overhead may thus increase. In addition, the receiving end may successively feed back an inter-phase difference value calculated with regard to each sub-band, instead of feeding back all at once. Therefore, a time difference occurs between the timepoint at which an inter-phase difference value regarding a specific sub-band is reported and a timepoint at which the corresponding inter-phase difference value is calculated. As a result, the data may be inappropriate at the timepoint at which the corresponding inter-phase difference value is reported (outdated report).

The disclosure described a feedback scheme regarding an inter-phase difference value between signals received by the receiving end (UE), based on a sounding reference signal (SRS) transmitted by the receiving end, such that limitations of feedback schemes regarding an inter-phase difference value between signals received by the receiving end, based on a codebook, may be remedied. More specifically, according to various embodiments of schemes described in the disclosure, two or more TRPs in CJT may estimate the inter-phase difference between signals received by the receiving end (UE) from two or more TRPs at a resource block (RB) level through an SRS transmitted by the receiving end (UE).

The followings may be presupposed (assumed) for various embodiments of schemes described in the disclosure.
(1) A coherence time may be guaranteed with regard to 2-3 consecutive symbols in the time domain. That is, it may be presumed that the channel regarding the n^{th} symbol and channel regarding the (n+1)^{th} symbol have the same value. According to an embodiment, it may be understood that, if 2-3 consecutive symbols in the time domain are related to the TRP/receiving end's operation for compensating for the inter-phase difference between received signals through an SRS, a coherence time is guaranteed between 2-3 consecutive symbols in the time domain. This may be expressed by equation hᵢ(n)≅hᵢ(n+1), wherein index n may be a symbol index which is valid only in a specific slot. Alternatively, above equation hᵢ(n)≅hᵢ(n+1) may also hold in the case of two different slots adjacent to each other. The above equation, when holding between two different slots adjacent to each other, may hold only between the last symbol of the first (previous) slot and the first symbol of the second (the latter of the two slots).
(2) The UE may apply a phase shift at the PRB level and then transmit an SRS. Application of the phase shift will hereinafter be described in more detail with reference to the drawings.

In the disclosure, for convenience of description, the following description will be made with regard to a system model including two TRPs and a UE capable of DL/UL transmission/reception from the two TRPs. The UE may measure the phase regarding downlink signals received from the two TRPs and may calculate the difference between respective phases. However, the above-mentioned system model is only for convenience of description, and schemes proposed in the disclosure may obviously be applied to a system model including at least two TRPs and a UE capable of transmitting/receiving signals with the at least two TRPs, measuring the phase regarding downlink signals received from the at least two TRPs, and calculating the difference between respective phases. The operating scheme in a system including two or more TRPs and a UE will hereinafter be described in more detail.

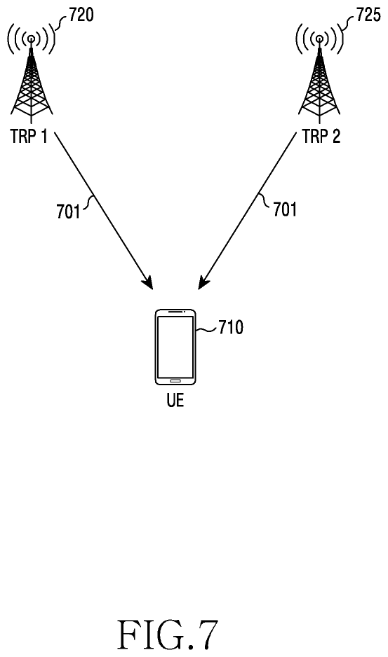

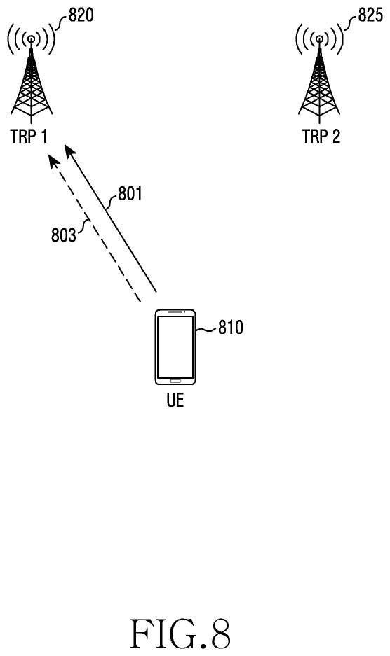

Hereinafter, a scheme for feeding back the inter-phase difference between signals received by the UE (receiving end), based on an SRS, will be described with reference to FIGS. 7 and 8.

FIG. 7 illustrates an example of a scheme for feeding back the inter-phase difference between signals received by a UE according to an embodiment of the disclosure. More specifically, FIG. 7 is related to a case in which, in a system including two TRPs and a UE, a scheme for feeding back the inter-phase difference between signals received by the UE is performed.

Referring to FIG. 7, (operation 1) the UE 710 may have a 2-port CSI-RS assigned thereto by TRP 1 720 or TRP 2 725, and respective 1-port CSI-RSs may be virtualized and transmitted from TRP 1 720 and TRP 2 725 to the UE 710, respectively (701). Assignment of a 2-port CSI-RS a to the UE 710 may be performed by one of TRP 1 720 or TRP 2 725, and higher layer signaling or dynamic signaling may be used for 2-port CSI-RS assignment. From the viewpoint of the UE, the UE 710 has a 2-port CSI-RS assigned thereto (logically), but may not know which CSI-RS is transmitted from which TRP. That is, the operation in which the UE 710 receives a CSI-RS from each of TRP 1 720 and TRP 2 725 may be understood as a UE transparent operation.

Referring back to FIG. 7, (operation 2) if the UE 710 has UE capability such that the phase may be measured with regard to a true channel (or quasi-true channel), the UE 710 may measure the phase of CSI-RSs received from TRP 1 720 and TRP 2 725, respectively, through a received 2-port CSI-RS. The phase of the CSI-RS measured by the UE 710 with regard to the 1-port CSI-RS received from TRP 1 720 may be e^{j(θ}^{₁}⁾, and the phase of the CSI-RS measured by the UE 710 with regard to the 1-port CSI-RS received from TRP 2 725 may be e^{j(θ}^{₂}⁾. Hereinafter, additional operations of the scheme for feeding back the inter-phase difference between received signals, based on an SRS, of the disclosure will be described with reference to FIG. 8.

FIG. 8 illustrates an example of a scheme for feeding back the inter-phase difference between signals received by a UE according to an embodiment of the disclosure. More specifically, FIG. 8 is related to a case in which, in a system including two TRPs and a UE, a scheme for feeding back the inter-phase difference between signals received by the UE is performed.

Referring to FIG. 8, (operation 3) the UE 810 may calculate the phase difference between phase values measured from 1-port CSI-RSs received from TRP 1 820 and TRP 2 825, respectively, based on phase values measured from 1-port CSI-RSs received from TRP 1 820 and TRP 2 825, respectively. In the case of (operation 3), according to whether the UE is capable of performing (operation 2) described with reference to FIG. 7 or not, the UE may perform a different scheme for calculating the phase difference between phase values measured from 1-port CSI-RSs received from TRP 1 820 and TRP 2 825, respectively.

Firstly, if the UE 810 is capable of performing (operation 2) in FIG. 7, the UE may calculate the inter-phase difference between phase values measured from 1-port CSI-RSs received from TRP 1 820 and TRP 2 825, respectively, with regard to each RB. As a result of calculation, the inter-phase difference between received signals, which has been calculated by the UE through phase values measured from 1-port CSI-RSs received from TRP 1 820 and TRP 2 825, respectively, may be e^{j(Δθ)}=e^{j(θ}^{₁}^{-θ}^{₂}⁾.

Next, if the UE 810 is incapable of performing (operation 2) in FIG. 7, the UE may calculate the inter-phase difference through a difference between signals measured with reference to an arbitrary reference phase, with regard to each RB, and this may be expressed as e^{j(Δθ)}=e^{j({θ}^{₁}^{-θ}^{_{ref}}^{}-{θ}^{₂}^{-θ}^{_{ref}}^{})}=e^{j(θ}^{₁}^{-θ}^{₂}⁾. That is, it is obvious that, although there is a difference in the detailed calculation process, the same inter-phase difference value is calculated consequently, regardless of whether the UE 810 is capable of performing (operation 2) in FIG. 7.

Referring to FIG. 8, (operation 4) the UE 810 may apply a phase shift based on a phase value measured based on CSI-RSs received from TRP 1 and TRP 2, respectively, measured in (operation 2) such that, on two different symbols adjacent to each other, an SRS is transmitted to TRP 1 820 at a symbol which is positioned first (which precedes) among the two different symbols adjacent to each other (801), and an SRS is transmitted to TRP 1 820 at a symbol which is positioned latter (which follows) among the two different symbols adjacent to each other (803). Although it is assumed that the UE transmits an SRS to TRP 1 820 for convenience of description, the UE may transmit an SRS either to TRP 1 820 or to TRP 2 825.

In this regard, the disclosure defines two phase shift schemes applied to two different SRSs transmitted on two different symbols adjacent to each other.

Firstly, among the two phase shift schemes applied to two different SRSs transmitted on two different symbols adjacent to each other, the first phase shift scheme may be based on inter-phase difference information calculated in (operation 3).

To describe the same in more detail with reference to FIG. 8, the UE 810 transmits an SRS to TRP 1 820 (or TRP 2 825) at the n^{th} symbol among two different symbols (n^{th} symbol and (n+1)^{th} symbol) adjacent to each other, and no phase shift may be applied to the SRS transmitted in the n^{th} symbol (801).

If TRP 1 820 (or TRP 2 825) has received the SRS transmitted by the UE 810 without applying a phase shift, the signal received by TRP 1 820 (or TRP 2 825) at the n^{th} symbol may be expressed by the following equation:

$$y ( n ) = {h}_{i} ( n ) x ( n ) + n ( n ) \qquad Equation 2$$

In the above equation, hᵢ(n) refers to a channel from the UE to TRP i at symbol n, x(n) refers to an SRS signal at symbol n, and n(n) refers to noise at symbol n.

Next, the UE 810 transmits an SRS to TRP 1 820 (or TRP 2 825) at the (n+1)^{th} symbol among two different symbols (n^{th} symbol and (n+1)^{th} symbol) adjacent to each other, a phase shift is applied to the SRS transmitted at the (n+1)^{th} symbol, and the applied phase shift value may be e^{j(Δθ)}, which is an inter-phase difference value calculated in (operation 3) (803).

If TRP 1 820 (or TRP 2 825) has received the SRS transmitted by the UE 810 by applying a phase shift, the received signal may be expressed by the following equation:

$$y ( n + 1 ) = {e}^{j ( Δ θ )} {h}_{i} ( n + 1 ) x ( n + 1 ) + n ( n + 1 ) \qquad Equation 3$$

In the above equation, hᵢ(n+1) refers to a channel from the UE to TRP i at symbol (n+1), x(n+1) refers to an SRS signal at symbol (n+1), and n(n+1) refers to noise at symbol (n+1). In addition, x(n+1)=x(n) is satisfied, and the SRS sequence transmitted at the n^{th} symbol by the UE and the SRS sequence transmitted at the (n+1)^{th} symbol by the UE may be identical.

Thereafter, upon receiving SRSs from the UE 810, the TRP (TRP 1 820 or TRP 2 825) may derive the inter-phase difference calculated by the UE from the SRSs received at the n^{th} symbol and the (n+1)^{th} symbol through the following equation:

$$y ( n + 1 ) / y ( n ) = ( {e}^{j ( Δ θ )} {h}_{i} ( n + 1 ) x ( n + 1 ) + n ( n + 1 ) ) / ( {h}_{i} ( n ) x ( n ) + n ( n ) ) ) = ( {e}^{j ( Δθ )} {h}_{i} ( n ) x ( n ) + n ( n ) ) / ( {h}_{i} ( n ) x ( n ) + n ( n ) ) ) = {e}^{j ( Δθ )} ( 1 + ϵ ) where ϵ is a very small value ≅ {e}^{j ( Δθ )} \qquad Equation 4$$

That is, upon receiving SRSs from the UE 810, the TRP (TRP 1 820 or TRP 2 825) may divide the signal y(n+1) received from the UE 810 at the (n+1)^{th} symbol by the signal y(n) received at the n^{th} symbol, thereby deriving the inter-phase difference calculated by the UE. In this regard, the premise of the disclosure that, if 2-3 consecutive symbols in the time domain are related to a TRP/UE's operation for compensating for the inter-phase difference between received signals through an SRS, a coherence time may be guaranteed between 2-3 consecutive symbols in the time domain, may be applied. That is, in the process in which the TRP (TRP 1 820 or TRP 2 825) divides the signal y(n+1) received from the UE 810 at the (n+1)^{th} symbol by the signal y(n) received at the n^{th} symbol, hᵢ(n+1) may be calculated as the same value as hᵢ(n), and n(n+1) may be calculated as the same value as n(n), based on the above premise. In addition, since x(n+1)=x(n) is satisfied (the SRS sequence transmitted at the n^{th} symbol by the UE and the SRS sequence transmitted at the (n+1)^{th} symbol by the UE are identical), the TRP (TRP 1 820 or TRP 2 825) may derive the inter-phase difference calculated by the UE by dividing the signal y(n+1) received from the UE 810 at the (n+1)^{th} symbol by the signal y(n) received at the n^{th} symbol.

Next, a phase shift value measured based on CSI-RSs received from TRP 1 and TRP 2, respectively, measured according to the second (operation 2) of the two phase shift schemes applied to two different SRSs transmitted on two different symbols adjacent to each other, may be used for the phase shift. That if, if the second phase shift scheme is followed, the inter-phase difference between received signals is not used, and the procedure corresponding to (operation 3) described above may thus be omitted.

More specifically, the UE 810 transmits an SRS to TRP 1 820 (or TRP 2 825) at the n^{th} symbol among two different symbols (n^{th} symbol and (n+1)^{th} symbol) adjacent to each other, and a phase shift that uses a phase value e^{jθ}^{₁} measured from a CSI-RS received from TRP 1 820 may be applied to the SRS transmitted at the n^{th} symbol (801).

If TRP 1 820 (or TRP 2 825) has received an SRS transmitted by the UE 810 by using a phase shift that uses a phase value e^{jθ}^{₁} measured from a CSI-RS received from TRP 1 820, the signal received by TRP 1 820 (or TRP 2 825) at the n^{th} symbol may be expressed by the following equation:

$$y ( n ) = {e}^{j {θ}_{1}} {h}_{i} ( n ) x ( n ) + n ( n ) \qquad Equation 5$$

In the above equation, hᵢ(n) refers to a channel from the UE to TRP i at symbol n, x(n) refers to an SRS signal at symbol n, and n(n) refers to noise at symbol n.

Next, the UE 810 transmits an SRS to TRP 1 820 (or TRP 2 825) at the (n+1)^{th} symbol among two different symbols (n^{th} symbol and (n+1)^{th} symbol) adjacent to each other, and a phase shift that uses a phase value e^{jθ}^{₂} measured from a CSI-RS received from TRP 2 825 may be applied to the SRS transmitted at the (n+1)^{th} symbol (803).

If TRP 1 820 (or TRP 2 825) has received the SRS transmitted by the UE 810 by applying a phase shift that uses a phase value e^{jθ}^{₂} measured from a CSI-RS received from TRP 2 825, the signal received by TRP 1 820 (or TRP 2 825) at the n^{th} symbol may be expressed by the following equation:

$$y ( n + 1 ) = {e}^{j {θ}_{2}} {h}_{i} ( n + 1 ) x ( n + 1 ) + n ( n + 1 ) \qquad Equation 6$$

In the above equation, hᵢ(n+1) refers to a channel from the UE to TRP i at symbol (n+1), x(n+1) refers to an SRS signal at symbol (n+1), and n(n+1) refers to noise at symbol (n+1). In addition, x(n+1)=x(n) is satisfied, and the SRS sequence transmitted at the n^{th} symbol by the UE and the SRS sequence transmitted at the (n+1)th symbol by the UE may be identical.

Thereafter, upon receiving SRSs from the UE 810, the TRP (TRP 1 820 or TRP 2 825) may derive the inter-phase difference from the SRSs received at the n^{th} symbol and the (n+1)^{th} symbol through the following equation:

$$y ( n + 1 ) / y ( n ) = ( {e}^{j {θ}_{2}} {h}_{i} ( n + 1 ) x ( n + 1 ) + n ( n + 1 ) ) / ( {e}^{j {θ}_{1}} {h}_{i} ( n ) x ( n ) + n ( n ) ) ) = ( {e}^{j ( Δθ )} {h}_{i} ( n ) x ( n ) + n ( n ) ) / ( {h}_{i} ( n ) x ( n ) + n ( n ) ) ) = {e}^{j ( Δθ )} ( 1 + ϵ ) where ϵ is a very small value \qquad Equation 7$$

That is, upon receiving SRSs from the UE 810, the TRP (TRP 1 820 or TRP 2 825) may divide the signal y(n+1) received from the UE 810 at the (n+1)^{th} symbol by the signal y(n) received at the n^{th} symbol, thereby deriving the inter-phase difference. In this regard, the premise of the disclosure that, if 2-3 consecutive symbols in the time domain are related to a TRP/UE's operation for compensating for the inter-phase difference between received signals through an SRS, a coherence time may be guaranteed between 2-3 consecutive symbols in the time domain, may be applied. That is, in the process in which the TRP (TRP 1 820 or TRP 2 825) divides the signal y(n+1) received from the UE 810 at the (n+1)^{th} symbol by the signal y(n) received at the n^{th} symbol, hᵢ(n+1) may be calculated as the same value as hᵢ(n), and n(n+1) may be calculated as the same value as n(n), based on the above premise. In addition, since x(n+1)=x(n) is satisfied (the SRS sequence transmitted at the n^{th} symbol by the UE and the SRS sequence transmitted at the (n+1)^{th} symbol by the UE are identical), the TRP (TRP 1 820 or TRP 2 825) may derive the inter-phase difference calculated by the UE by dividing the signal y(n+1) received from the UE 810 at the (n+1)^{th} symbol by the signal y(n) received at the n^{th} symbol.

Hereinafter, a method for assigning CSI-RS resources and assigning SRS resources according to various embodiments of the disclosure will be described. That is, various embodiments of the disclosure described hereinafter may relate to CSI-RS resource assignment and SRS transmission resource assignment for feedback by a UE for compensating for the inter-phase difference between signals received from different TRPs by the UE.

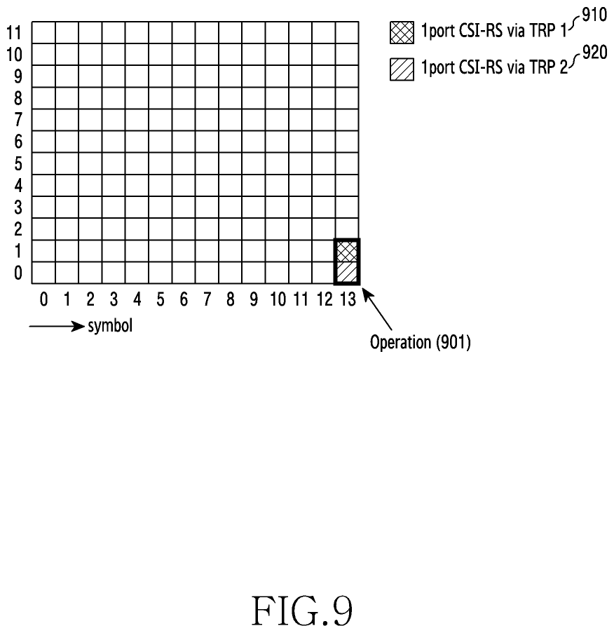

Firstly, CSI-RS resource assignment will be described with reference to FIG. 9.

FIG. 9 illustrates an example of CSI-RS resource assignment according to an embodiment of the disclosure. More specifically, FIG. 9 illustrates an example of operations in a system including two TRPs and a UE.

Referring to FIG. 9, an example of a 2-port CSI-RS assigned to the UE by one of the two TRPs is illustrated. Respective 1-port CSI-RSs may be virtualized and then transmitted from the two TRPs to the UE, respectively.

If the UE has UE capability such that the same may measure the phase with regard to a true channel (or quasi-true channel), the UE may measure the phase of CSI-RSs 910 and 920 received from TRP 1 and TRP 2, respectively, through the received 2-port CSI-RS (901). As used herein, the true channel may refer to an actual channel, which is not a channel estimated by the UE, or a channel close to the actual channel. The phase of a CSI-RS measured with regard to the 1-port CSI-RS 910, which the UE has received from one of the two TRPs, may be e^{j(θ}^{₁}⁾, and the phase of a CSI-RS measured with regard to the 1-port CSI-RS 920, which the UE has received from the other of the two TRPs, may be e^{j(θ}^{₂}⁾. If the UE is configured to operate based on the phase shift scheme based on inter-phase difference information, which is the first of the two phase shift schemes defined in the disclosure, the UE may calculate e^{j(Δθ)}, which is an inter-phase difference value between received signals, based on e^{j(θ}^{₁}⁾ and e^{j(θ}^{₂}⁾ values.

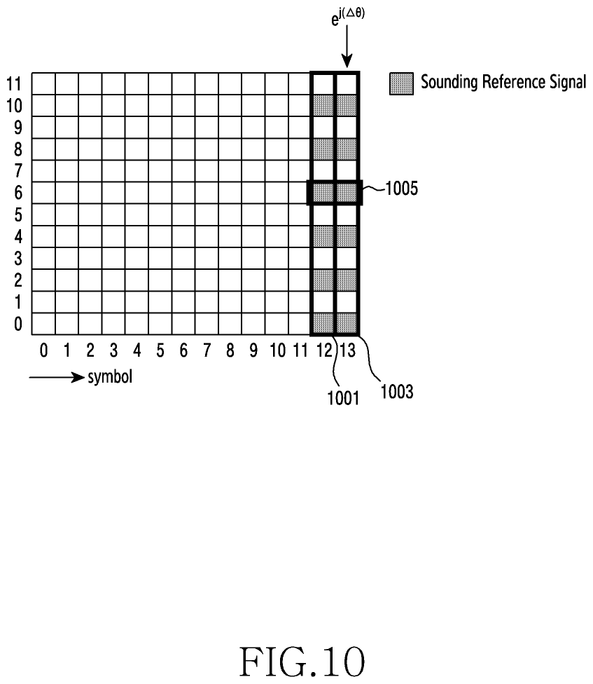

Next, SRS transmission resource assignment will be described with reference to FIG. 10.

FIG. 10 illustrates an example of SRS transmission resource assignment according to an embodiment of the disclosure. More specifically, FIG. 10 illustrates an example of operations in a system including two TRPs and a UE and operations to which the first scheme (phase shift scheme based on inter-phase difference information) is applied, among the two phase shift schemes applied to two different SRSs transmitted on two different symbols adjacent to each other, described above.

Referring to FIG. 10, an SRS transmission resource may be assigned/mapped to specific REs (RE index 0, 2, 4, 6, and 10) in an RB on two different symbols adjacent to each other, the symbol index of which is 12 and 13, in a slot. In the case of FIG. 10, the UE transmits an SRS to a TRP which performs phase calibration at a symbol having a symbol index of 12 among the two different symbols adjacent to each other (the symbol having a symbol index of 12 and the symbol having a symbol index of 13), and no phase shift may be applied to the SRS transmitted at the symbol having a symbol index of 12 (1001). Next, the UE transmits an SRS to a TRP which performs phase calibration at a symbol having a symbol index of 13 among the two different symbols adjacent to each other (the symbol having a symbol index of 12 and the symbol having a symbol index of 13), a phase shift is applied to the SRS transmitted at the symbol having a symbol index of 13, and the applied phase shift value may be e^{j(Δθ)}, which is an inter-phase difference value calculated by the UE (1003). The phase shift value applied to symbol index 13 has the same value in all resources used to transmit the SRS in the RB, and the same phase shift value may be applied with regard to a single RB or to each group of multiple RBs.

For example, FIG. 10 illustrates an example of SRS transmission using one RB. However, if SRS transmission that uses multiple RBs is assigned, and if a configuration is made such that the same phase shift value is applied with regard to a single RB, a e^{j(Δθ)} value calculated separately with regard to each RB may be applied to each RB.

Alternatively, if SRS transmission that uses multiple RBs is assigned, and if a configuration is made such that the same phase shift value is applied with regard to each group of RBs, the number of which is identical to the number of RBs assigned for the SRS transmission, a common phase different value (e^{j(Δθcommon)}) derived as a specific computation result regarding a e^{j(Δθ)} value calculated separately with regard to each RB may be equally applied to multiple RBs. The common phase difference value (e^{j(Δθcommon)}) may be configured as the average value of e^{j(Δθ)} values separately calculated in respective RBs, or configured as a representative phase difference value derived in a specific RB (which is predefined or configured by higher layer signaling or the like) among multiple RBs, or configured as the average value of representative phase differences derived in at least one specific RB (which is predefined or configured by higher layer signaling or the like) among multiple RBs.

Alternatively, if SRS transmission that uses multiple RBs is assigned, and if a configuration is made such that the same phase shift value is applied with regard to each group of sub-RBs, the number (e.g., two) of which is smaller than the number (e.g., four) of RBs assigned for the SRS transmission, the same scheme may be applied with regard to each group of sub-RBs as in the case of making a configuration such that the same phase shift value is applied with regard to each group of RBs, the number of which is identical to the number of RBs assigned for SRS transmission. More specifically, assuming that four RBs (RB #0, RB #1, RB #2, RB #3) constitute two sub-RBs, and each of the two sub-RBs is configured such that (sub-RB #0 includes RB #0 and RB #1, and sub-RB #1 includes RB #2 and RB #3), a common phase different value (e^{j(Δθcommon)}) derived as a specific computation result regarding a e^{j(Δθ)} value calculated separately with regard to each of the two RBs included in sub-RB #0 may be equally applied to the two RBs included in sub-RB #0. The common phase difference value (e^{j(Δθcommon)}) may be configured as the average value of e^{j(Δθ)} values separately calculated in respective RBs, or configured as a representative phase difference value derived in a specific RB (which is predefined or configured by higher layer signaling or the like) among multiple RBs, or configured as the average value of representative phase differences derived in at least one specific RB (which is predefined or configured by higher layer signaling or the like) among multiple RBs.

In addition, a common phase different value (e^{j(Δθcommon)}) derived as a specific computation result regarding a e^{j(Δθ)} value calculated separately with regard to each of the two RBs included in sub-RB #1 may be equally applied to the two RBs included in sub-RB #1. The common phase difference value (e^{j(Δθcommon)}) may be configured as the average value of e^{j(Δθ)} values separately calculated in respective RBs, or configured as a representative phase difference value derived in a specific RB (which is predefined or configured by higher layer signaling or the like) among multiple RBs, or configured as the average value of representative phase differences derived in at least one specific RB (which is predefined or configured by higher layer signaling or the like) among multiple RBs.

It is obvious that, in the example of FIG. 10, the symbol index to which an SRS transmission resource is assigned and the location of the RE in the RB are only examples for description, and the SRS transmission resource may be assigned in various different manners from the example of FIG. 10.

Thereafter, upon receiving SRSs from the UE, the TRP that performs phase calibration may derive the inter-phase difference calculated by the UE from the SRSs received at the symbol having a symbol index of 12 and the symbol having a symbol index of 13 (1005).

The operations described with reference to FIG. 10 may be similarly applied to the scheme in which a phase value measured based on a CSI-RS received from each of two TRPs is used for the phase shift, among the two phase shift schemes of the disclosure. More specifically, there may be a difference in terms of UE operations in that, in the case of 1001 in FIG. 10, a phase shift that uses a phase value e^{jθ}^{₁} measured from a CSI-RS received from one of the two TRPs may be applied to the SRS transmitted at the symbol having a symbol index of 12, and in the case of 1003, the UE operates such that a phase shift that uses a phase value e^{jθ}^{₂} measured from a CSI-RS received from one of the two TRPs is applied to the SRS transmitted at the symbol having a symbol index of 12.

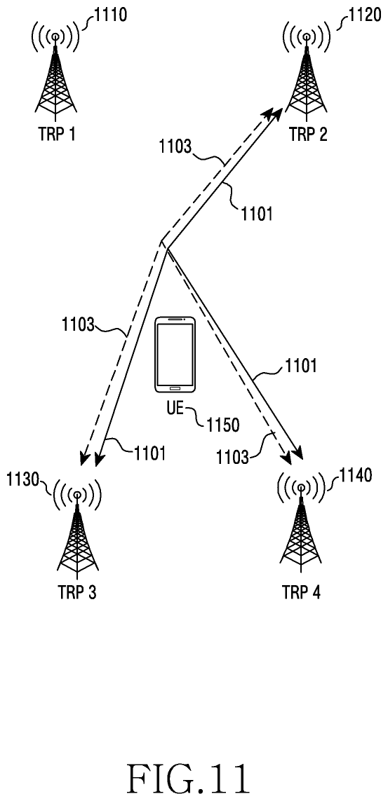

Hereinafter, a scheme for feeding back the inter-phase difference between signals received by the UE (receiving end) in system model including two or more TRPs and a UE will be described with reference to FIG. 11 to FIG. 13.

FIG. 11 illustrates an example of a scheme for feeding back the inter-phase difference between signals received by the UE according to an embodiment of the disclosure. More specifically, FIG. 11 relates to a case in which a scheme for feeding back the inter-phase difference between signals received by the UE is performed in a system including four TRPs and a UE.

Referring to FIG. 11, in order to maximize the performance gain through CJT, it may be necessary that, when the UE receives signals from the four TRPs, respectively, there be no inter-phase difference between signals received from the four TRPs, respectively. Therefore, each of the phases of signals received from three TRPs which perform phase calibration, among the four TRPs, at the timepoint of reception by the UE needs to be able to be equal to the phase of the signal received from a specific TRP at the timepoint of reception by the UE (phases needs to be able to be synchronized). That is, if the phase of the signal received from a specific TRP at the timepoint of reception by the UE is π/2 (rad), each of the phases of signals received from the remaining three TRPs at the timepoint of reception by the UE may have to satisfy π/2 (rad). Hereinafter, among all TRPs, a specific TRP with which phases of signals received from the remaining TRPs at the timepoint of reception by the UE need to be synchronized will be referred to as a reference TRP for convenience of description. In the case of FIG. 11, TRP 1 1110 may be understood as the reference TRP.

Although not illustrated in FIG. 11, the UE has a 4-port CSI-RS assigned thereto by one of the four TRPs 1110, 1120, 1130, and 1140, and respective 1-port CSI-RSs may be virtualized and transmitted from TRP 1 1110, TRP 2 1120, TRP 3 1130, and TRP 4 1140 to the UE 1150, respectively. The 4-port CSI-RS may be assigned to the UE 1150 by using higher layer signaling or dynamic signaling. From the viewpoint of the UE, the UE 1150 has a 4-port CSI-RS assigned thereto (logically), but may not know which CSI-RS is transmitted from which TRP. That is, the operation in which the UE 1150 receives 1-port CSI-RSs from TRP 1 1110, TRP 2 1120, TRP 3 1130, and TRP 4 1140, respectively, may be a UE transparent operation.

Although not illustrated in FIG. 11, if the UE 1150 has UE capability such that the same may measure the phase with regard to a true channel (or quasi-true channel), the UE 1150 may measure the phase of CSI-RSs received from TRP 1 1110, TRP 2 1120, TRP 3 1130, and TRP 4 1140, respectively, through the received 4-port CSI-RS. The phase of a CSI-RS measured with regard to the 1-port CSI-RS, which the UE 1150 has received from TRP 1 1110, may be e^{j(θ}^{₁}⁾, and the phase of a CSI-RS measured with regard to the 1-port CSI-RS, which the UE 1150 has received from TRP 2 1120, may be e^{j(θ}^{₂}⁾. In addition, the phase of a CSI-RS measured with regard to the 1-port CSI-RS, which the UE 1150 has received from TRP 3 1130, may be e^{j(θ}^{₃}⁾, and the phase of a CSI-RS measured with regard to the 1-port CSI-RS, which the UE 1150 has received from TRP 4 1140, may be e^{j(θ}^{₄}⁾.

Although not illustrated in FIG. 11, if the UE 1150 has UE capability such that the same may measure the phase with regard to a true channel (or quasi-true channel), the UE 1150 may, with regard to each RB, (1) calculate the inter-phase difference between phase values measured from 1-port CSI-RSs which the UE has received from TRP 1 1110 (reference TRP) and TRP 2 1120, respectively (e^{j(Δθ}^{₂}⁾=e^{j(θ}^{₁}^{-θ}^{₂}⁾), (2) calculate the inter-phase difference between phase values measured from 1-port CSI-RSs which the UE has received from TRP 1 1110 (reference TRP) and TRP 3 1130, respectively (e^{j(Δθ}^{₃}⁾=e^{j(θ}^{₁}^{-θ}^{₃}⁾), and (3) calculate the inter-phase difference between phase values measured from 1-port CSI-RSs which the UE has received from TRP 1 1110 (reference TRP) and TRP 4 1140, respectively (e^{j(Δθ}^{₄}⁾=e^{j(θ}^{₁}^{-θ}^{₄}⁾). That is, calculations (1) to (3) above are performed in one RB, and calculations (1) to (3) above may be performed with regard to each of at least one RB assigned in relation to operations for compensating for the inter-phase difference between signals received by the UE.

Although not illustrated in FIG. 11, if the UE 1150 has UE capability such that the same may measure the phase with regard to a true channel (or quasi-true channel), the UE 1150 may, with regard to each RB, calculate the inter-phase difference through a difference in signals measured with reference to an arbitrary reference phase. In addition, the UE may (1) calculate the inter-phase difference between phase values measured from 1-port CSI-RSs which the UE has received from TRP 1 1110 (reference TRP) and TRP 2 1120, respectively (e^{j(Δθ}^{₂}⁾=e^{j({θ}^{₁}^{-θ}^{_{ref}}^{}-{θ}^{₂}^{-θ}^{_{ref}}^{})}=e^{j(θ}^{₁}^{-θ}^{₂}⁾), (2) calculate the inter-phase difference between phase values measured from 1-port CSI-RSs which the UE has received from TRP 1 1110 (reference TRP) and TRP 3 1130, respectively (e^{j(Δθ}^{₃}⁾=e^{j({θ}^{₁}^{-θ}^{_{ref}}^{}-{θ}^{₃}^{-θ}^{_{ref}}^{)}}=e^{j(θ}^{₁}^{-θ}^{₃}⁾), and (3) calculate the inter-phase difference between phase values measured from 1-port CSI-RSs which the UE has received from TRP 1 1110 (reference TRP) and TRP 4 1140, respectively (e^{j(Δθ}^{₄}⁾=e^{j({θ}^{₁}^{-θ}^{_{ref}}^{}-{θ}^{₄}^{-θ}^{_{ref}}^{})}=e^{j(θ}^{₁}^{-θ}^{₄}⁾). That is, calculations (1) to (3) above are performed in one RB, and calculations (1) to (3) above may be performed with regard to each of at least one RB assigned in relation to operations for compensating for the inter-phase difference between signals received by the UE. It may be understood that, although there is a difference in the detailed calculation process, the same value of inter-phase difference is consequently calculated regardless of whether the UE is capable of measuring the phase with regard to a true channel (or quasi-true channel).

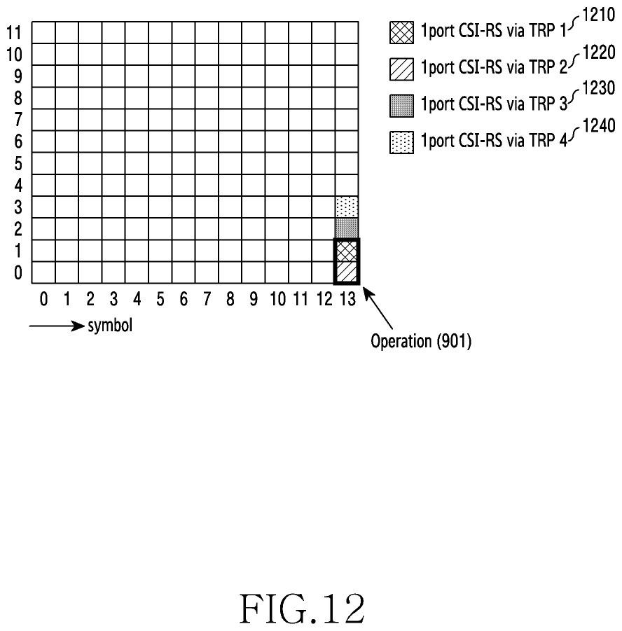

Operations in which the UE 1150 receives 1-port CSI-RSs from TRP 1 1110, TRP 2 1120, TRP 3 1130, and TRP 4 1140, respectively, and measures phases (e^{j(θ}^{₁}⁾, e^{j(θ}^{₂}⁾, e^{j(θ}^{₃}⁾, e^{j(θ}^{₄}⁾) of the received CSI-RSs, described above, will now be described with reference to FIG. 12 from the viewpoint of resource assignment.

FIG. 12 illustrates an example of CSI-RS resource assignment according to an embodiment of the disclosure. More specifically, FIG. 12 illustrates an example of operations in a system including four TRPs and a UE.

Referring to FIG. 12, an example of a 4-port CSI-RS resource assigned to the UE from one of the four TRPs is illustrated. Respective 1-port CSI-RSs may be virtualized and transmitted from the four TRPs to the UE, respectively.

If the UE has UE capability such that the same may measure the phase with regard to a true channel (or quasi-true channel), the UE may measure the phase of CSI-RSs 1210, 1220, 1230, and 1240 received from TRP 1 (reference TRP), TRP 2, TRP 3, and TRP 4, respectively, through the received 4-port CSI-RS. The UE may receive 1-port CSI-RSs from TRP 1 1210, TRP 2 1220, TRP 3 1230, and TRP 4 1240, respectively, and may represent phases of CSI-RSs measured with regard to the received CSI-RSs to be e^{j(θ}^{₁}⁾, e^{j(θ}^{₂}⁾, e^{j(θ}^{₃}⁾, e^{j(θ}^{₄}⁾. If the UE is configured to operate based on the phase shift scheme based on inter-phase difference information, which is the first of the two phase shift schemes defined in the disclosure, the UE may calculate e^{j(Δθ}^{₂}⁾=e^{j(θ}^{₁}^{-θ}^{₂}⁾), e^{j(Δθ}^{₃}⁾=e^{j(θ}^{₁}^{-θ}^{₃}⁾ and e^{(Δθ}^{₄}⁾=e^{j(θ}^{₁}^{-θ}^{₄}⁾, which are inter-phase difference values between received signals, based on e^{j(θ}^{₁}⁾, e^{j(θ}^{₂}⁾, e^{j(θ}^{₃}⁾, e^{j(θ}^{₄}⁾ values.

Referring back to FIG. 11, the UE 1150 may apply a phase shift based on phases (e^{j(θ}^{₁}⁾, e^{(θ}^{₂}⁾, e^{j(θ}^{₃}⁾, e^{j(θ}^{₄}⁾ of CSI-RSs measured with regard to 1-port CSI-RSs received from TRP 1 1110, TRP 2 1120, TRP 3 1130, and TRP 4 1140, respectively, such that SRSs are transmitted to TRP 2 1120, TRP 3 1130, and TRP 4 1140, respectively, except for TRP 1 1110 (reference TRP), at a symbol which is positioned first (which precedes) among the two different symbols adjacent to each other (1101), and SRSs are transmitted to TRP 2 1120, TRP 3 1130, and TRP 4 1140, respectively, except for TRP 1 1110 (reference TRP), at a symbol which is positioned latter (which follows) among the two different symbols adjacent to each other (1103).

If the phase shift operation in FIG. 11 follows the first scheme, which uses phase difference information, among the two phase shift schemes defined in the disclosure, the UE 1150 transmits SRSs to TRP 2 1120, TRP 3 1130, and TRP 4 1140, respectively, at the n^{th} symbol among two different symbols (n^{th} symbol and (n+1)^{th} symbol) adjacent to each other, and no phase shift may be applied to the SRSs transmitted in the n^{th} symbol (1101).

If TRP 2 1120, TRP 3 1130, and TRP 4 1140 have received SRSs transmitted by the UE 1150 without applying a phase shift, the signals (SRSs) received by TRP 2 1120, TRP 3 1130, and TRP 4 1140, respectively, at the n^{th} symbol may be expressed by the following equation:

$$y ( n ) = {h}_{i} ( n ) x ( n ) + n ( n ) \qquad Equation 8$$

In the above equation, hᵢ(n) refers to a channel from the UE to TRP i at symbol n, x(n) refers to an SRS signal at symbol n, and n(n) refers to noise at symbol n.

Next, the UE 1150 transmits an SRS to TRP 2 1120, TRP 3 1130, and TRP 4 1140 at the (n+1)^{th} symbol among two different symbols (n^{th} symbol and (n+1)^{th} symbol) adjacent to each other, a phase shift is applied to the SRS transmitted at the (n+1)^{th} symbol, and the applied phase shift value may be e^{j(Δθ}^{₂}⁾=e^{j(θ}^{₁}^{-θ}^{₂}⁾), e^{j(Δθ}^{₃}⁾=e^{j(θ}^{₁}^{-θ}^{₃}⁾, and e^{j(Δθ}^{₄}⁾=^{j(θ}^{₁}^{-θ}^{₄}⁾, which are inter-phase difference values calculated by the UE with regard to TRP 2 1120, TRP 3 1130, and TRP 4 1140, respectively (803).

If TRP 1 (or TRP 2) has received the SRS transmitted by the UE by applying a phase shift, the received signal may be expressed by the following equation:

$$y ( n + 1 ) = {e}^{j ( {Δθ}_{i} )} {h}_{i} ( n + 1 ) x ( n + 1 ) + n ( n + 1 ) \qquad Equation 9$$

In the above equation, e^{j(Δθ}^{ᵢ}⁾ refers to an inter-phase difference calculated with regard to the reference TRP and TRP i, hᵢ(n+1) refers to a channel from the UE to TRP i at symbol (n+1), x(n+1) refers to an SRS signal at symbol (n+1), and n(n+1) refers to noise at symbol (n+1). In addition, x(n+1)=x(n) is satisfied, and the SRS sequence transmitted at the n^{th} symbol by the UE and the SRS sequence transmitted at the (n+1)^{th} symbol by the UE may be identical.

Thereafter, upon receiving SRSs at the n^{th} symbol and the (n+1)^{th} symbol from the UE 1150, TRP 2 1120, TRP 3 1130, and TRP 4 1140 may derive the inter-phase difference calculated by the UE from the SRSs received at the n^{th} symbol and the (n+1)^{th} symbol through the following equation:

$$y ( n + 1 ) / y ( n ) = ( {e}^{j ( {Δθ}_{i} )} {h}_{i} ( n + 1 ) x ( n + 1 ) + n ( n + 1 ) ) / ( {h}_{i} ( n ) x ( n ) + n ( n ) ) ) = ( {e}^{j ( {Δθ}_{i} )} {h}_{i} ( n ) x ( n ) + n ( n ) ) / ( {h}_{i} ( n ) x ( n ) + n ( n ) ) ) = {e}^{j ( {Δθ}_{i} )} ( 1 + ϵ ) where ϵ is a very small value ≅ {e}^{j ( {Δθ}_{i} )} \qquad Equation 10$$

That is, upon receiving an SRS from the UE 1150, each of TRP 2 1120, TRP 3 1130, and TRP 4 1140 may divide the signal y(n+1) received from the UE 1150 at the (n+1)^{th} symbol by the signal y(n) received at the n^{th} symbol, thereby deriving the inter-phase difference calculated by the UE. In this regard, the premise of the disclosure that, if 2-3 consecutive symbols in the time domain are related to a TRP/UE's operation for compensating for the inter-phase difference between received signals through an SRS, a coherence time may be guaranteed between 2-3 consecutive symbols in the time domain, may be applied. That is, in the process in which each of TRP 2 1120, TRP 3 1130, and TRP 4 1140 divides the signal y(n+1) received from the UE 160 at the (n+1)^{th} symbol by the signal y(n) received at the n^{th} symbol, hᵢ(n+1) may be calculated as the same value as hᵢ(n), and n(n+1) may be calculated as the same value as n(n), based on the above premise. In addition, since x(n+1)=x(n) is satisfied (the SRS sequence transmitted at the n^{th} symbol by the UE and the SRS sequence transmitted at the (n+1)^{th} symbol by the UE are identical), each of TRP 2 1120, TRP 3 1130, and TRP 4 1140 may derive the inter-phase difference calculated by the UE by dividing the signal y(n+1) received from the UE 1150 at the (n+1)^{th} symbol by the signal y(n) received at the n^{th} symbol.

Next, if the phase shift operation in FIG. 11 follows the second scheme in which phase values measured based on CSI-RSs received from TRPs, respectively, are directly used for a phase shift, among the two phase shift schemes defined in the disclosure, the UE 1150 transmits SRSs to TRP 2 1120, TRP 3 1130, and TRP 4 1140, respectively, at the n^{th} symbol among two different symbols (n^{th} symbol and (n+1)^{th} symbol) adjacent to each other, and a phase shift that uses a phase value e^{jθ}^{₁} measured from a CSI-RS received from TRP 1 1110 (reference TRP) may be applied to the SRS transmitted at the n^{th} symbol (1101).

If each of TRP 2 1120, TRP 3 1130, and TRP 4 1140 has received an SRS transmitted by the UE 1150 by applying a phase shift that uses a phase value e^{jθ}^{₁} measured from a CSI-RS received from TRP 1 1110 (reference TRP), the signal (SRS) received by each of TRP 2 1120, TRP 3 1130, and TRP 4 1140 at the n^{th} symbol may be expressed by the following equation:

$$y ( n ) = {e}^{j {θ}_{1}} {h}_{i} ( n ) x ( n ) + n ( n ) \qquad Equation 11$$

In the above equation, hᵢ(n) refers to a channel from the UE to TRP i at symbol n, x(n) refers to an SRS signal at symbol n, and n(n) refers to noise at symbol n.

Next, the UE 1150 transmits an SRS to each of TRP 2 1120, TRP 3 1130, and TRP 4 1140 at the (n+1)^{th} symbol among two different symbols (n^{th} symbol and (n+1)^{th} symbol) adjacent to each other, and a phase shift may be applied to the SRS transmitted at the (n+1)^{th} symbol such that e^{jθ}^{₂}, e^{jθ}^{₃}, and e^{jθ}^{₄} are used, respectively, according to the TRP which is supposed to receive a phase value SRS measured from the CSI-RS received from TRP 1 (reference TRP) (1103).

If each of TRP 2 1120, TRP 3 1130, and TRP 4 1140 has received an SRS transmitted by applying a phase shift that such that e^{jθ}^{₂}, e^{jθ}^{₃}, and e^{jθ}^{₄} are used, respectively, according to the TRP which is supposed to receive an SRS as phase values (e^{jθ}^{₂}, e^{jθ}^{₃}, and e^{jθ}^{₄}) measured from the CSI-RS which the UE 1150 has received from each of TRP 2 1120, TRP 3 1130, and TRP 4 1140, the signal received by each of TRP 2 1120, TRP 3 1130, and TRP 4 1140 at the (n+1)^{th} symbol may be expressed by the following equation:

$$y ( n + 1 ) = {e}^{j {θ}_{i}} {h}_{i} ( n + 1 ) x ( n + 1 ) + n ( n + 1 ) \qquad Equation 12$$

In the above equation, e^{j(θ}^{ᵢ₎} refers to the phase of a CSI-RS measured by the UE with regard to a 1-port CSI-RS transmitted by TRP i which performs phase calibration with reference to the reference TRP, hᵢ(n+1) refers to a channel from the UE to TRP i at symbol (n+1), x(n+1) refers to an SRS signal at symbol (n+1), and n(n+1) refers to noise at symbol (n+1). In addition, x(n+1)=x(n) is satisfied, and the SRS sequence transmitted at the n^{th} symbol and the SRS sequence transmitted at the (n+1)^{th} symbol by the UE may be identical.

Thereafter, upon receiving SRSs from the UE 1150 at the n^{th} symbol and the (n+1)^{th} symbol, TRP 2 1120, TRP 3 1130, and TRP 4 1140 may derive the inter-phase difference between signals received by the UE (that is, between the signal received from the reference TRP and each of the signals received from the remaining TRPs) from SRSs received at the n^{th} symbol and the (n+1)^{th} symbol through the following equation:

$$y ( n + 1 ) / y ( n ) = ( {e}^{j θ} {h}_{i} ( n + 1 ) x ( n + 1 ) + n ( n + 1 ) ) / ( {e}^{j {θ}_{1}} {h}_{i} ( n ) x ( n ) + n ( n ) ) ) = ( {e}^{j ( {Δθ}_{i} )} ( n ) x ( n ) + n ( n ) ) / ( {h}_{i} ( n ) x ( n ) + n ( n ) ) ) = {e}^{j ( {Δθ}_{i} )} ( 1 + ϵ ) where ϵ is a very small value \qquad Equation 13$$

That is, upon receiving an SRS from the UE 1150, each of TRP 2 1120, TRP 3 1130, and TRP 4 1140 may divide the signal y(n+1) received from the UE 1150 at the (n+1)^{th} symbol by the signal y(n) received at the n^{th} symbol, thereby deriving the inter-phase difference calculated by the UE. In this regard, the premise of the disclosure that, if 2-3 consecutive symbols in the time domain are related to a TRP/UE's operation for compensating for the inter-phase difference between received signals through an SRS, a coherence time may be guaranteed between 2-3 consecutive symbols in the time domain, may be applied. That is, in the process in which each of TRP 2 1120, TRP 3 1130, and TRP 4 1140 divides the signal y(n+1) received from the UE 1150 at the (n+1)^{th} symbol by the signal y(n) received at the n^{th} symbol, hᵢ(n+1) may be calculated as the same value as hᵢ(n), and n(n+1) may be calculated as the same value as n(n), based on the above premise. In addition, since x(n+1)=x(n) is satisfied (the SRS sequence transmitted at the n^{th} symbol by the UE and the SRS sequence transmitted at the (n+1)^{th} symbol by the UE are identical), each of TRP 2 1120, TRP 3 1130, and TRP 4 1140 may derive the inter-phase difference calculated by the UE by dividing the signal y(n+1) received from the UE 1150 at the (n+1)^{th} symbol by the signal y(n) received at the n^{th} symbol.

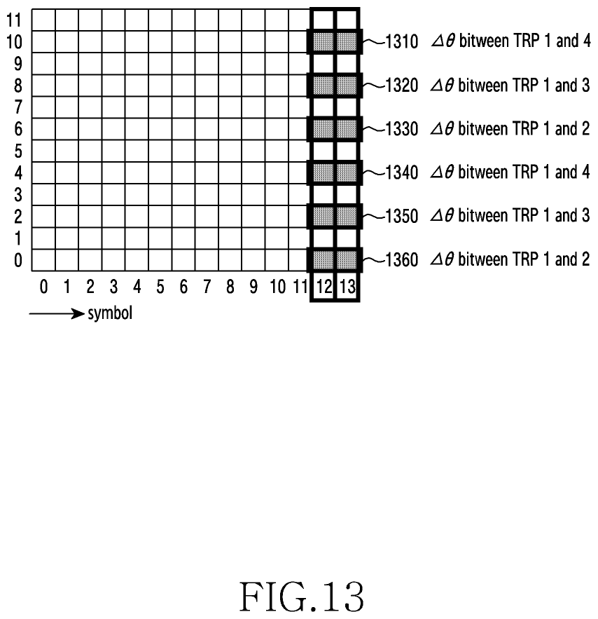

The UE-related SRS transmission resource assignment in FIG. 11 will now be described with reference to FIG. 13.

FIG. 13 illustrates an example of SRS transmission resource assignment according to an embodiment of the disclosure. More specifically, FIG. 13 illustrates an example of operations in a system including four TRPs and a UE and operations to which the first scheme (phase shift scheme based on inter-phase difference information) is applied, among the two phase shift schemes applied to two different SRSs transmitted on two different symbols adjacent to each other, described above.

Referring to FIG. 13, SRS transmission resources regarding TRP 2 1120, TRP 3 1130, and TRP 4 1140, respectively, which perform phase calibration, may be assigned/mapped to specific REs (RE index 0, 2, 4, 6, and 10) in an RB on two different symbols adjacent to each other, the symbol index of which is 12 and 13, in a slot. More specifically, the RE location of an SRS transmission resource for phase calibration between reference TRP 1 1110 and TRP 2 1120 may be assigned to the locations 1330 and 1360 having RE indices 0 and 6 in the RB, the RE location of an SRS transmission resource for phase calibration between reference TRP 1 1110 and TRP 3 1130 may be assigned to the locations 1320 and 1350 having RE indices 2 and 8 in the RB, and the RE location of an SRS transmission resource for phase calibration between reference TRP 1 1110 and TRP 4 1140 may be assigned to the locations 1310 and 1340 having RE indices 4 and 10 in the RB. However, the symbol index location of SRS transmission resources in FIG. 13, locations of RE resources in the RB, and the mapping between locations of RE resources and TRPs supposed to receive SRSs are only examples for description, and it is obvious that the symbol index location of SRS transmission resources in FIG. 13, locations of RE resources in the RB, and the mapping between locations of RE resources and TRPs supposed to receive SRSs may be configured differently from those illustrated in FIG. 13.

Referring again to FIG. 13, the UE transmits SRSs to TRP 2 1120, TRP 3 1130, and TRP 4 1140, respectively, which perform phase calibration, at a symbol having a symbol index of 12 among two different symbols adjacent to each other (a symbol having a symbol index of 12 and a symbol having a symbol index of 13), and no phase shift may be applied to the SRS transmitted at the symbol having a symbol index of 12.

Next, the UE transmits SRSs to TRP 2 1120, TRP 3 1130, and TRP 4 1140, respectively, which perform phase calibration, at a symbol having a symbol index of 13 among two different symbols adjacent to each other (a symbol having a symbol index of 12 and a symbol having a symbol index of 13), and a phase shift is applied to the SRS transmitted at the symbol having a symbol index of 13, and the applied phase shift value may be e^{j(Δθ}^{ᵢ}⁾, which is an inter-phase difference value calculated by the UE with regard to each TRP. e^{j(Δθ}^{ᵢ}⁾ represents an inter-phase difference calculated with regard to the reference TRP and TRP i. The phase shift value applied to symbol index 13 may have the same value in all REs related to TRPs supposed to receive the same SRS in the same RB.

Hereinafter, methods in which, based on an SRS transmitted by a UE to a TRP that performs phase calibration, the TRP calculates an inter-phase difference for phase calibration with regard to each RB will be described. Phase calibration may refer to an operation in which a specific TRP applies an inter-TRP inter-phase difference value calculated through an SRS received from a UE to downlink signals such that the phase of signals transmitted thereby and received by the UE becomes identical to the phase of signals transmitted by the reference TRP and received by the UE.

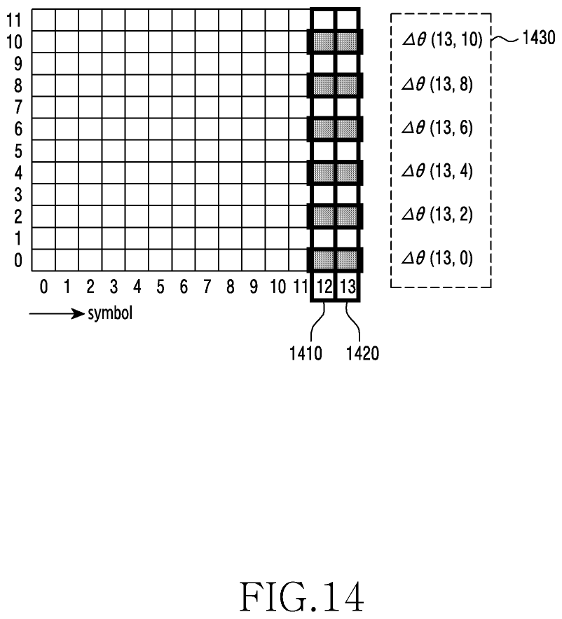

FIG. 14 illustrates examples of a method for calculating an inter-phase difference according to an embodiment of the disclosure. FIG. 14 relates to a situation in which operations for phase calibration between two TRPs and a UE are performed.

Referring to FIG. 14, the UE may transmit an SRS to a TRP that performs phase calibration at symbol n 1410 and may transmit an SRS to the TRP that performs phase calibration at symbol (n+1) 1420.

As an example of the method for calculating the inter-phase difference between received signals, the TRP that performs phase calibration may calculate the inter-phase difference between the phase of signals transmitted by the reference TRP and received by the UE and the phase of signals transmitted by the TRP that performs phase calibration and received by the UE, through SRSs received at symbol n and symbol (n+1) according to the following equation:

$$Δθ j ( n ) = \frac{1}{\vert 𝒦 \vert} {\sum }_{k ∈ 𝒦} Δθ j ( n , k ) \qquad Equation 14$$

In the above equation, set [symbol] is configured by subcarrier indices assigned to an SRS, Δθj(n,k) refers to the inter-phase difference between symbol n and symbol (n+1) at subcarrier k included in set [symbol] , and Δθj(n) refers to the average value of inter-phase difference values calculated from all subcarriers included in set [symbol] , respectively, between symbol n and symbol (n+1).

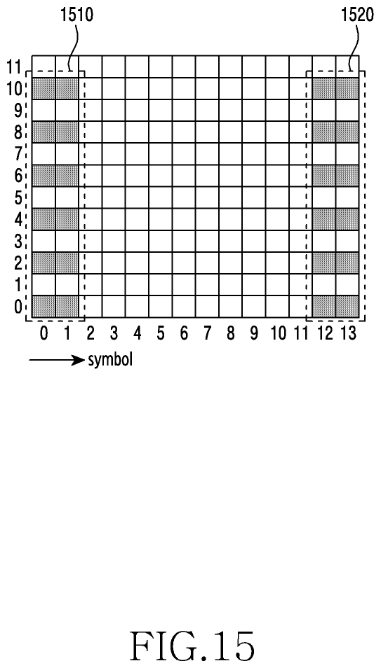

FIG. 15 illustrates other examples of a method for calculating the inter-phase difference according to an embodiment of the disclosure. FIG. 15 relates to a situation in which operations for phase calibration between two TRPs and a UE are performed.

Referring to FIG. 15, as an example of the method for calculating the inter-phase difference between received signals, assuming that the TRP that performs phase calibration receives an SRS for phase calibration from the UE two times or more (1510 and 1520), the inter-phase difference between phases of signals transmitted by the TRP that performs phase calibration and received by the UE may be calculated according to the following equation:

$$Δθ j = \frac{1}{\vert 𝒩 \vert} {\sum }_{n ∈ 𝒩} Δθ j ( n ) \qquad Equation 15$$

In the above equation, Δθj(n) is identical to Δθj(n) in Equation 14 above, and set [symbol] may be configured by symbol indices assigned to an SRS. That is, if an SRS is transmitted i times at different timepoints through two symbols, [symbol] may have a value of i.

As an example of the method for calculating the inter-phase difference between received signals, assuming that the TRP that performs phase calibration receives an SRS for phase calibration from the UE at a specific timepoint (1520), the phase difference value calculated through the SRS 1510 for phase calibration received prior to the specific timepoint may be taken into account when calculating the phase difference value through the SRS received at the specific timepoint. Operations according to this example may be calculated according to the following equation:

$$Δ \overline{θ} j ( n ) = ( 1 - τ ) \cdot Δ \overline{θ} j ( n - 1 ) + τ \cdot Δθ j ( n ) \qquad Equation 16$$

In the above equation, τ may be a moving window size, and this may be understood as being equivalent to a weight applicable to the phase difference value calculated at a specific timepoint at which an SRS is received, and to the phase difference value calculated through an SRS received prior to the specific timepoint. That is, assuming that the phase difference value calculated at a specific timepoint at which an SRS is received is 10, the phase difference value calculated through an SRS received prior to the specific timepoint is 8, and τ has a value of 0.5, then the phase difference value calculated at the specific timepoint may be (1−0.5)*8+0.5*10=9.

Hereinafter, a method in which a TRP that performs phase calibration calculates the inter-phase difference and then determines whether the calculated inter-phase difference is valid information, will be described.

Firstly, a method for determining whether the inter-phase difference is valid will be described assuming that an SRS for phase calibration is transmitted at least two times from a UE in one slot, or that an SRS for phase calibration is transmitted at least two times from a UE in two slots adjacent to each other.

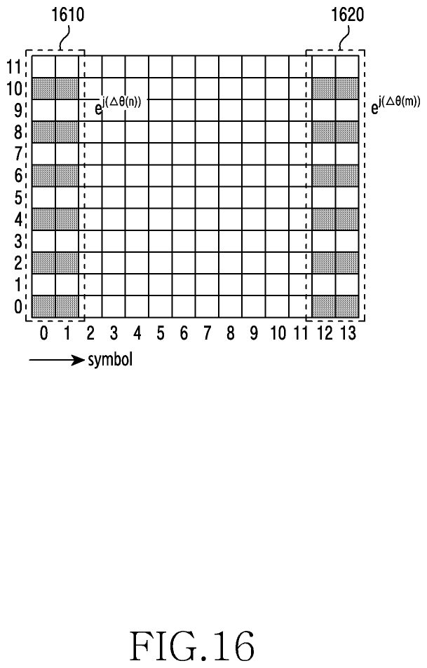

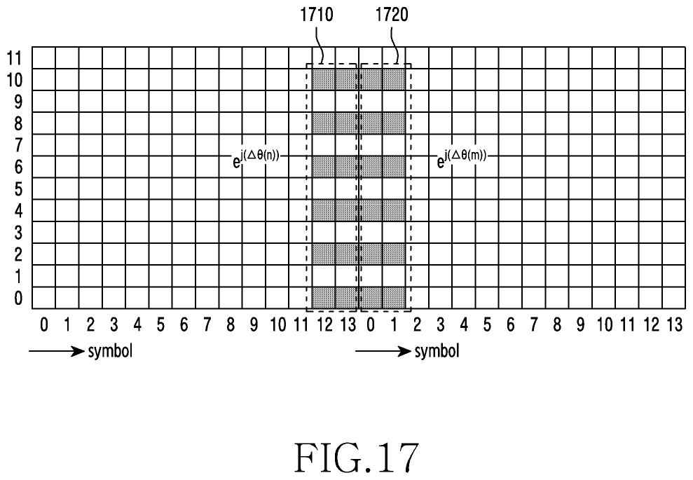

FIGS. 16 and 17 illustrate an example of a method for determining the validity of a phase difference calculated by a TRP according to various embodiments of the disclosure.

Referring to FIG. 16, an example in which two SRSs for phase calibration are transmitted (1610 and 1620) twice from a UE in one slot is illustrated.

Referring to FIG. 17 an example in which two SRSs for phase calibration are transmitted twice from a UE in two slots adjacent to each other is illustrated.

The validity of the calculated inter-phase difference may be determined according to the same method in both cases illustrated in FIGS. 16 and 17. The validity of two inter-phase differences calculated at different timepoints may be determined according to whether the absolute value of a phase difference value (1610/1710) calculated through two SRSs transmitted first, among two SRSs transmitted twice and the absolute value of a phase difference value (1620/1720) calculated through two SRSs transmitted later are smaller than a specific threshold value (that is, |Δθ(n)−Δθ(m)|<threshold). The parameter threshold regarding a threshold value may be an optimized parameter, Δθ(n) may be an average inter-phase difference value calculated through SRSs transmitted on symbol n and symbol (n+1), and Δθ(m) may be an average inter-phase difference value calculated through SRSs transmitted on symbol m and symbol (m+1).

Next, a method for determining whether the inter-phase difference is valid will be described assuming that SRSs for phase calibration are transmitted from a UE in different slots not adjacent to each other.

In this method, when determining the validity of an inter-phase difference calculated through SRSs transmitted on symbol m and symbol (m+1) in a specific slot, an inter-phase difference calculated through SRSs transmitted on symbol n and symbol (n+1) in a slot which is not adjacent to the specific slot, and which precedes the specific slot, is used, and the inter-phase difference value based on moving window size τ, described above with reference to Equation 16, may be used for the inter-phase difference calculated through SRSs transmitted on symbol n and symbol (n+1) in a slot which precedes the specific slot.

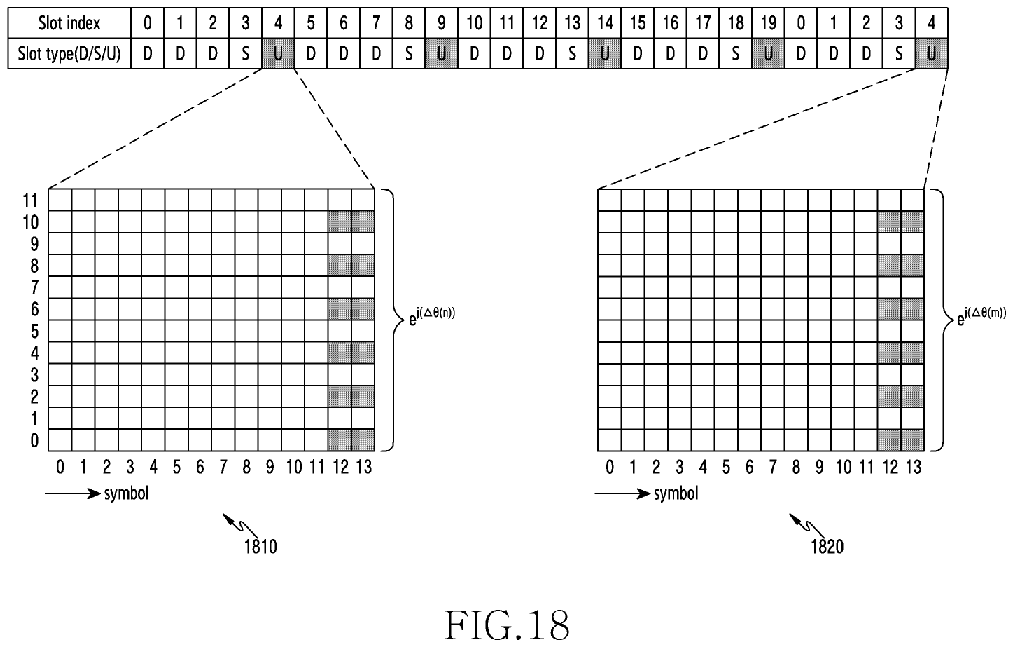

FIG. 18 illustrate an example of a method for determining the validity of a phase difference calculated by a TRP according to an embodiments of the disclosure.

Referring to FIG. 18, the validity of an inter-phase difference calculated through SRSs transmitted on symbol 12 and symbol 13 in a specific slot 1820 may be determined by comparing the absolute value of a value obtained by subtracting an inter-phase difference calculated through SRSs transmitted on symbol 12 and symbol 13 in the specific slot 1820 from an inter-phase difference based on moving window size T, calculated through SRSs transmitted on symbol 12 and symbol 13 in a slot 1810 that precedes the specific slot 1820, with a threshold value (|Δθ̅(n)−Δθ(m)|<threshold). If the absolute value of a value obtained by subtracting an inter-phase difference calculated through SRSs transmitted on symbol 12 and symbol 13 in the specific slot 1820 from an inter-phase difference based on moving window size T, calculated through SRSs transmitted on symbol 12 and symbol 13 in a slot 1810 that precedes the specific slot 1820 is smaller than the threshold value, the inter-phase difference calculated through SRSs transmitted on symbol 12 and symbol 13 may be deemed valid.

Hereinafter, a signaling message necessary to perform a feedback method for phase calibration between received signals of the disclosure will be described. The signaling message is, for example, an RRC message.

In the case of a usage information element (IE) which indicates the usage of a resource set for SRS transmission, included in parameter SRS-ResourceSet which indicates a resource set for SRS transmission, usage “calibration” may be added to the resource set for SRS transmission to indicate that the same is used for phase calibration between signals received by a UE during a multi-TRP operation. That is, in addition to “beam management”, “codebook based” or “non-codebook based transmission” or “antenna switching” usage included in the existing usage field, the usage field may indicate that the corresponding SRS resource set is used for “calibration” usage.

If “calibration” usage is added to the usage field, the related specifications may be changed (underlined) as follows:

TABLE 1
38.331, usage field definition
Indicates if the SRS resource set is used for beam management, codebook
based or non-codebook based transmission or antenna switching or
calibration.
See TS 38.214 [19], clause 6.2.1. Reconfiguration between codebook
based and non-codebook based transmission is not supported.

In addition, a calibrationGranularity IE may be added to parameter SRS-Resource that indicates an SRS resource related to a resource set for SRS transmission, and the calibrationGranularity IE is configured such that, for example, calibrationGranularity={wideband, n1, n2, n4, . . . }. The calibrationGranularity IE may indicate a value regarding the unit of the number of RBs in the frequency domain, to which a phase shift is applied, when a phase shift is applied to two SRSs transmitted for phase calibration. That is, assuming that 8 RBs are configured to transmit an SRS on two symbols for phase calibration, and that calibrationGranularity=n1 is configured, the same value of phase shift regarding the SRS transmitted on two symbols may be applied with regard to each RB (that is, a separately calculated phase difference value is applied with regard to every RB). In addition, assuming that 8 RBs are configured to transmit an SRS on two symbols for phase calibration, and that calibrationGranularity=n2 is configured, the same value of phase shift regarding the SRS transmitted on two symbols may be applied with regard to every two RBs. In addition, assuming that 8 RBs are configured to transmit an SRS on two symbols for phase calibration, and that calibrationGranularity=wideband is configured, the same value of phase shift regarding the SRS transmitted on two symbols may be applied with regard to every RB. More specifically, the description that the same phase shift value is applied with regard to an RB may mean that the same phase shift value is applied with regard to REs in the RB to which the same phase shift value is applied.

In addition, a calibrationRS IE may be added to parameter SRS-Resource that indicates an SRS resource related to a resource set for SRS transmission. The calibrationRS IE may be a parameter for indicating a CSI-RS resource related to an SRS transmitted for phase calibration. That is, when the UE transmits an SRS on a specific SRS resource by applying a phase shift for phase calibration, information regarding a CSI-RS resource that the UE needs to receive, in order to acquire the value of phase shift applied to the SRS transmitted on the specific SRS resource, may be included in the calibrationRS IE.

Various types of calibrationRS IE that may be configured according to various embodiments of the disclosure will now be described.

Firstly, a calibrationRS IE configuration applicable to a situation in which two TRPs and a UE transmit/receive signals will be described. When the calibrationRS IE indicates a 2-port CSI-RS resource transmitted for phase calibration, it may be assumed that two subcarriers are configured on one symbol in order to transmit a 2-port CSI-RS resource in one RB, and no code division multiplexing (CDM) is applied between CSI-RS resources. Then, the 1-port CSI-RS transmitted by TRP 1 (reference TRP) may be assigned to the subcarrier corresponding to RE index 0, and the 1-port CSI-RS transmitted by TRP 2 may be assigned to the subcarrier corresponding to RE index 1. Accordingly, the UE may obtain phase value e^{j(θ}^{₁}⁾ through the 1-port CSI-RS transmitted on the subcarrier corresponding to RE index 0 of TRP 1, and the UE may obtain phase value e^{j(θ}^{₂}⁾ through the 1-port CSI-RS transmitted on the subcarrier corresponding to RE index 1 of TRP 2. The inter-phase difference between signals received by TRP 1 (reference TRP) and TRP 2, respectively, may be calculated by subtracting the phase of signals received by the UE with regard to TRP 2 from the phase of signals received by the UE with regard to TRP 1.

Next, a calibrationRS IE configuration applicable to a situation in which n (>2) TRPs and a UE transmit/receive signals will be described.

According to the first type of the calibrationRS IE configuration applicable to a situation in which n (>2) TRPs and a UE transmit/receive signals, the IE configuration may be configured by expanding and applying the same type of calibrationRS IE configuration described above with regard to a situation in which two TRPs and a UE transmit/receive signals to a situation in which n (>2) TRPs and a UE transmit/receive signals. That is, when an n-port CSI-RS resource transmitted for phase calibration is indicated, it may be assumed that n subcarriers are configured on one symbol in order to transmit an n-port CSI-RS resource in one RB, and no code division multiplexing (CDM) is applied between CSI-RS resources. A 1-port CSI-RS transmitted by the reference TRP, among n TRPs, may be assigned onto a subcarrier corresponding to the lowest RE index in the RB on one symbol of the slot in which the CSI-RS is transmitted. Assuming that a TRP index (identifier) having an integer value of 2 to n is given to the remaining (n-1) TRPs in a predetermined manner, the 1-port CSI-RS transmitted by each of the (n-1) TRPs may be assigned onto a subcarrier corresponding to an RE index in the RB in the ascending order of the given TRP index. The inter-phase difference between signals received by the reference TRP and each of the remaining TRPs may be calculated by subtracting the phase of signals received by the UE with regard to each of the remaining TRPs from the phase of signals received by the UE with regard to the reference TRP. As an example, when the calibrationRS IE indicates a 4-port CSI-RS transmitted for phase calibration, it may be assumed that four subcarriers are configured on one symbol to transmit a 4-port CSI-RS in one RB, and no code division multiplexing (CDM) is applied between CSI-RS resources. Then, the 1-port CSI-RS transmitted by TRP 1 (reference TRP) may be assigned onto the subcarrier corresponding to RE index 0, the 1-port CSI-RS transmitted by TRP 2 may be assigned onto the subcarrier corresponding to RE index 1, the 1-port CSI-RS transmitted by TRP 3 may be assigned onto the subcarrier corresponding to RE index 2, and the 1-port CSI-RS transmitted by TRP 4 may be assigned onto the subcarrier corresponding to RE index 3. Accordingly, the UE may obtain phase value e^{j(θ}^{₁}⁾ through the 1-port CSI-RS transmitted on the subcarrier corresponding to RE index 0 of TRP 1, the UE may obtain phase value e^{j(θ}^{₂}⁾ through the 1-port CSI-RS transmitted on the subcarrier corresponding to RE index 1 of TRP 2, the UE may obtain phase value e^{j(θ}^{₃}⁾ through the 1-port CSI-RS transmitted on the subcarrier corresponding to RE index 1 of TRP 3, and the UE may obtain phase value e^{j(θ}^{₄}⁾ through the 1-port CSI-RS transmitted on the subcarrier corresponding to RE index 1 of TRP 2. The inter-phase difference between signals received by the TRP1 (reference TRP) and each of TRP 2 to TRP 4 may be calculated by subtracting the phase of signals received by the UE with regard to each of TRP 2 to TRP 4 from the phase of signals received by the UE with regard to TRP 1.

According to the second type of the calibrationRS IE configuration applicable to a situation in which n (>2) TRPs and a UE transmit/receive signals, the calibrationRS IE configuration may be configured such that a CSI-RS resource for calculating a phase shift value corresponding to an SRS transmitted at a specific subcarrier index in an RB related to SRS transmission is separately indicted with regard to each subcarrier index in the RB.

More specifically, a calibrationRSList may be configured, the calibrationRSList may be configured as a list including calibrationRSs, and the n^{th} calibrationRS included in the calibrationRSList may indicate an RS for calculating a phase shift value to be applied to the subcarrier for the n^{th} SRS in the RB.

As an example, the calibrationRSList may be configured in the following format:
calibrationRSList::=SEQUENCE (SIZE(1 . . . 6)) OF calibrationRS

In this case, the calibrationRSList is configured per one RB, and when an SRS resource is configured in a comb n2 type in one RB, the number of subcarriers for transmitting an SRS, which may be configured in one RB, is six. Therefore, the calibrationRSList may be configured to include six calibrationRSs. For example, in a situation in which a UE transmits/receives signals with seven TRPs, it is necessary to calibrate the inter-phase difference between TRP 1 (reference TRP) and each of the remaining TRPs 2 to 7. If SRSs are transmitted in a comb n2 type on two consecutive symbols in one RB, respective SRSs may be transmitted at six subcarriers. That is, a first SRS for phase calibration between TRP 1 and TRP 2, a second SRS for phase calibration between TRP 1 and TRP 3, a third SRS for phase calibration between TRP 1 and TRP 4, a fourth SRS for phase calibration between TRP 1 and TRP 5, a fifth SRS for phase calibration between TRP 1 and TRP 6, and sixth SRS for phase calibration between TRP 1 and TRP 7 may be transmitted. In this case, the calibrationRSList may include information regarding a first 2-port CSI-RS resource related to a phase shift applied during first SRS transmission, a second 2-port CSI-RS resource related to a phase shift applied during second SRS transmission, a third 2-port CSI-RS resource related to a phase shift applied during third SRS transmission, a fourth 2-port CSI-RS resource related to a phase shift applied during fourth SRS transmission, a fifth 2-port CSI-RS resource related to a phase shift applied during fifth SRS transmission, and a sixth 2-port CSI-RS resource related to a phase shift applied during sixth SRS transmission.

In addition, according to the third type of the calibrationRS IE configuration applicable to a situation in which n (>2) TRPs and a UE transmit/receive signals, the calibrationRS IE configuration may be configured such that a pattern in which a phase shift is applied with regard to subcarriers in an RB related to SRS transmission is configured, and in the order of the lowest subcarrier index in the configured pattern, a 2-port CSI-RS resource for calculating an inter-phase difference applied during SRS transmission is indicated.

More specifically, a calibrationRSList may be configured, the calibrationRSList may be configured as a list of calibrationRSs, and the n^{th} calibrationRS may indicate a CSI-RS resource for calculating a phase shift value to be applied to a subcarrier group having the n^{th} lowest subcarrier group index among all subcarrier groups including subcarriers to which the same phase shift is applied in the phase shift pattern preconfigured in the RB.

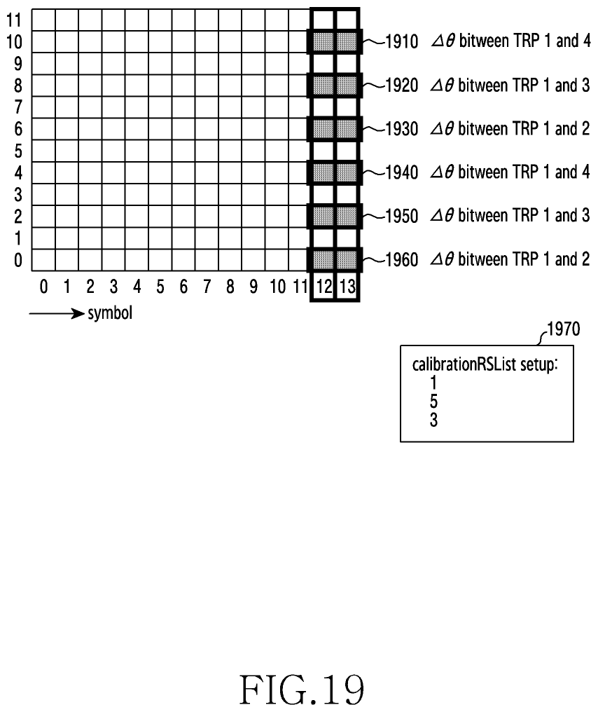

The third type of the calibrationRS IE configuration applicable to a situation in which n (>2) TRPs and a UE transmit/receive signals will now be described in more detail with reference to FIG. 19.

FIG. 19 illustrates an example of the calibrationRSList configuration according to an embodiment of the disclosure. More specifically, FIG. 19 illustrates a case in which four TRPs and a UE transmit/receive signals, and SRS resource assignment is configured in a comb n2 pattern (that is, SRS-usage RE density per symbol=½).

Referring to FIG. 19, a phase shift pattern may be configured such that a first SRS for phase calibration between TRP 1 (reference TRP) and TRP 2 is transmitted at subcarriers 1960 and 1930 corresponding to RE indices 0 and 6 while applying the same phase shift thereto, a second SRS for phase calibration between TRP 1 (reference TRP) and TRP 3 is transmitted at subcarriers 1950 and 1920 corresponding to RE indices 2 and 8 while applying the same phase shift thereto, and a third SRS for phase calibration between TRP 1 (reference TRP) and TRP 4 is transmitted at subcarriers 1940 and 1910 corresponding to RE indices 4 and 10 while applying the same phase shift thereto. Subcarrier units to which the same phase shift is applied may be grouped into a subcarrier group. A first subcarrier group (subcarrier group index=1) may be configured to include subcarriers 1960 and 1930 corresponding to RE indices 0 and 6, a second subcarrier group (subcarrier group index=2) may be configured to include subcarriers 1950 and 1920 corresponding to RE indices 2 and 8, and a third subcarrier group (subcarrier group index=3) may be configured to include subcarriers 1940 and 1910 corresponding to RE indices 4 and 10. The calibrationRSList 1970 may include a calibrationRS(=1) regarding a first 2-port CSI-RS resource related to calculation of a phase shift applied in the first subcarrier group having the lowest subcarrier group index, a calibrationRS(=5) regarding a second 2-port CSI-RS resource related to calculation of a phase shift applied in the second subcarrier group having the second lowest subcarrier group index, and a calibrationRS(=3) regarding a third 2-port CSI-RS resource related to calculation of a phase shift applied in the third subcarrier group having the highest subcarrier group index. Phase shifts of e^{j(θ}^{₁}^{-θ}^{₂}⁾, e^{j(θ}^{₁}^{-θ}^{₃}⁾, and e^{j(θ}^{₁}^{-θ}^{₄}⁾ may be applied to SRSs transmitted in the first to third subcarrier groups, respectively.

Referring to FIG. 19, the pairs of subcarrier indices included in the first, second, and third subcarrier groups are only example, and the subcarrier groups may obviously be modified and configured variously. In addition, assignment of subcarrier group indices to the first, second, and third subcarrier groups is only an example, and it is obvious that subcarrier group indices may be assigned in various manners different from that in FIG. 19, and the calibrationRSList may be configured based on the ascending order of assigned group indices. Additionally, unlike FIG. 19, in an RB in which an SRS is transmitted, locations of subcarriers to which different phase shifts e^{j(θ}^{₁}^{-θ}^{₂}⁾, e^{j(θ}^{₁}^{-θ}^{₃}⁾, and e^{j(θ}^{₁}^{-θ}^{₄}⁾ are applied may be configured through RRC signaling.

Hereinafter, parameters necessarily included in an RRC configuration IE for a phase calibration method of the disclosure will be described.

Parameter nrofSymbols may be necessarily included in parameter resourceMapping included in parameter SRS-Resource for indicating an SRS resource.

Parameter nrofSymbols may be included in the RRC configuration IE in a format as in Table 2 below:

TABLE 2

| SRS-Resource ::= SEQUENCE { | |
|---|---|
| ... | |
| resourceMapping SEQUENCE { | |
| startPosition | INTEGER (0..5), |
| nrofSymbols | ENUMERATED {n1, n2, n4}, |
| repetitionFactor | ENUMERATED {n1, n2, n4} |

},

If an SRS for phase calibration usage is configured for both consecutive symbol n and symbol (n+1) at which an SRS is transmitted, parameter nrofSymbols may be configured such that nrofSymbols=n2.

Alternatively, in connection with consecutive symbol n and symbol (n+1) at which an SRS is transmitted, if one of SRS usage={beamManagement, codebook, nonCodebook, antennaSwitching} is configured for symbol n, and if SRS usage={calibration} is additionally configured for symbol (n+1), parameter nrofSymbols may be configured such that nrofSymbols=n1.

Particularly, if an SRS is used for an SRS-based beamforming (BF) usage other than phase calibration, additional SRS assignment may be a burden. In such a case, an SRS for calibration usage may be additionally assigned to only one symbol at a location adjacent to an already assigned SRS symbol location.

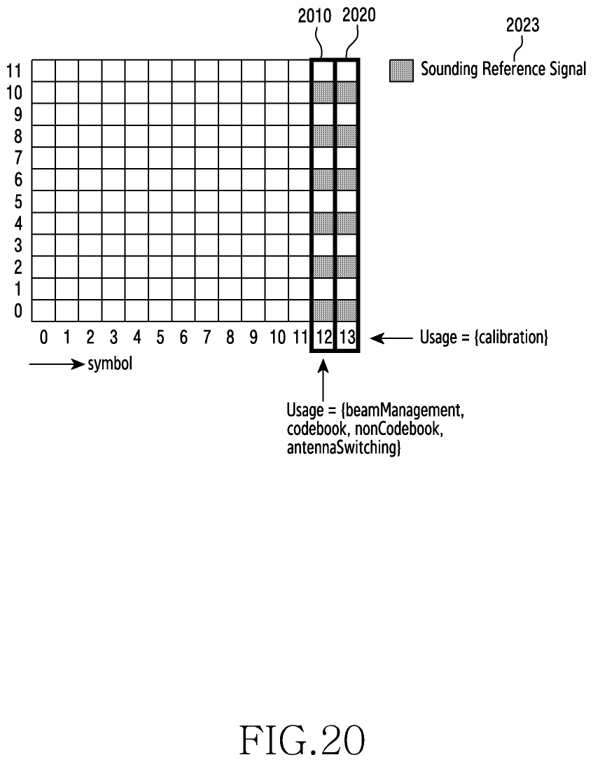

FIG. 20 illustrates an example of a necessary RRC configuration parameter configuration according to an embodiment of the disclosure.

Referring to FIG. 20, in connection with consecutive symbol 12 2010 and symbol 13 2020 at which an SRS 2023 is transmitted, if one of SRS usage={beamManagement, codebook, nonCodebook, antennaSwitching} is configured for symbol 12, an SRS may be configured for symbol 13 such that SRS usage={calibration}, and parameter nrofSymbols may then be configured such that nrofSymbols=n.

In addition, it may be necessary to include parameter freqHopping IE which is included in parameter SRS-Resource for indicating an SRS resource. If a frequency hopping function is enabled, c-SRS, b-SRS, b-hop may be equally configured with regard to two consecutive SRS symbols.

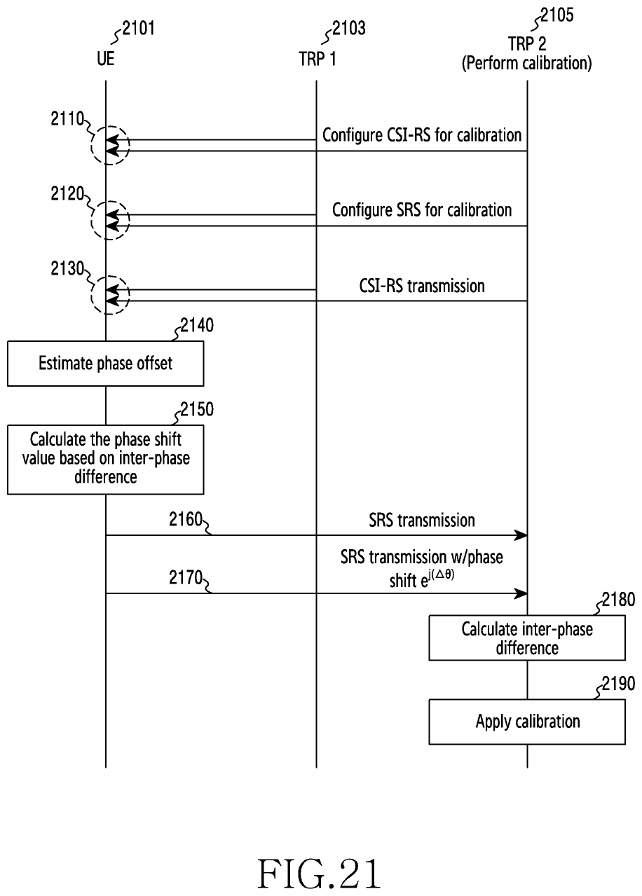

FIG. 21 illustrates an example in which a feedback scheme for phase calibration between received signals is performed according to an embodiment of the disclosure.

In operation 2110, the UE 2101 has a 2-port CSI-RS assigned thereto from TRP 1 2103 or TRP 2 2105 which performs phase calibration. From the viewpoint of the UE, the UE 2101 has a 2-port CSI-RS assigned thereto (logically), but may not know which CSI-RS is transmitted from which TRP. That is, the operation in which the UE 2101 receives a CSI-RS from each of TRP 1 2103 and TRP 2 2105 may be understood as a UE transparent operation.

In operation 2120, the UE 2101 may receive a configuration related to an SRS to be transmitted for phase calibration from TRP 1 2103 or TRP 2 2105 which performs phase calibration.

In operation 2130, the 2-port CSI-RS assigned to the UE 2101 from TRP 1 2103 or TRP 2 2105 may be virtualized to 1-port CSI-RSs and then transmitted from TRP 1 2103 or TRP 2 2105 to the UE 2102, respectively.

In operations 2140 and 2150, the UE 2101 may calculate the phase of a CSI-RS from each of received 2-port CSI-RSs, and may calculate the inter-phase difference between received signals, based on calculated phase values.

In operations 2160 and 2170, the UE 2101 may transmit an SRS on two adjacent symbols to TRP 2 2105 which performs phase calibration. No phase shift may be applied to the SRS transmitted at the first symbol, and a phase shift corresponding to the inter-phase difference value calculated in operation 2140 may be applied to the SRS transmitted at the second symbol. Alternatively, if no inter-phase difference between received signals has been calculated in operation 2150, the UE 2101 may transmit an SRS on two adjacent symbols to TRP 2 2105 which performs phase calibration. A phase shift corresponding to the phase value calculated from the CSI-RS received from TRP 1 2103 may be applied to the SRS transmitted at the first symbol, and a phase shift corresponding to the phase value calculated from the CSI-RS received from TRP 2 2105 may be applied to the SRS transmitted at the second symbol.

In operation 2180, TRP 2 2105 may divide the value of an SRS signal received at the (n+1)^{th} symbol by the value of an SRS signal received at the n^{th} symbol ((y(n+1)/y(n) operation), thereby estimating the inter-phase difference.

In operation 2190, thereafter, TRP 2 2105 may perform phase calibration, based on the inter-phase difference estimated in operation 2180.

Thereafter, although not illustrated in FIG. 21, the UE may receive first downlink data from TRP 1 and may receive second downlink data, which has undergone phase calibration, from TRP 2.

Through the disclosure, phase calibration for CJT may be performed at the PRB level. In addition, through the disclosure, accurate inter-phase difference estimation may be performed, compared with a codebook-based feedback scheme in which the inter-phase difference is fed back by using a limited overhead. In addition, through the disclosure, phase calibration may be performed based on the estimated inter-phase difference, thereby maximizing the CJT's performance (=DL throughput).

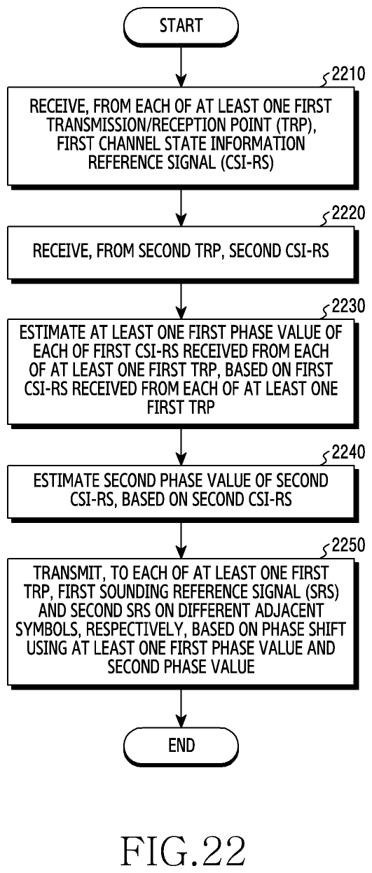

FIG. 22 is a flowchart illustrating an example in which a UE's operating method is performed according to an embodiment of the disclosure.

Referring to FIG. 22, the UE may receive, from each of at least one first transmission/reception point (TRP), a first channel state information reference signal (CSI-RS) at operation 2210.

Next, the UE may receive, from a second TRP, a second CSI-RS at operation 2220.

Next, the UE may estimate at least one first phase value of each of the first CSI-RS received from each of the at least one first TRP, based on the first CSI-RS received from each of the at least one first TRP at operation 2230.

Thereafter, the UE may estimate a second phase value of the second CSI-RS, based on the second CSI-RS at operation 2240.

Next, the UE may transmit, to each of the at least one first TRP, a first sounding reference signal (SRS) and a second SRS on different adjacent symbols, respectively, based on a phase shift using the at least one first phase value and the second phase value at operation 2250.

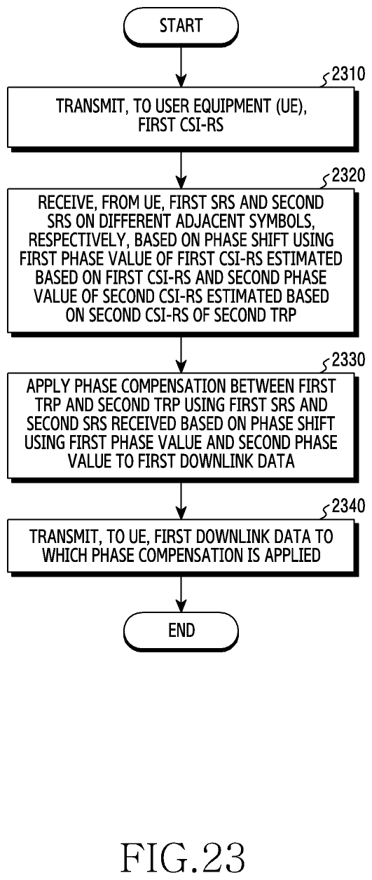

FIG. 23 is a flowchart illustrating an example in which a TRP's operating method is performed according to an embodiment of the disclosure.

Referring to FIG. 23, the TRP may transmit, to a user equipment (UE), a first CSI-RS at operation 2310.

Next, the TRP may receive, from the UE, a first SRS and a second SRS on different adjacent symbols, respectively, based on a phase shift using a first phase value of the first CSI-RS estimated based on the first CSI-RS and a second phase value of a second CSI-RS estimated based on the second CSI-RS of a second TRP at operation 2320.

Next, the TRP may apply a phase compensation between the first TRP and the second TRP using the first SRS and the second SRS received based on the phase shift using the first phase value and the second phase value to first downlink data at operation 2330.

Next, the TRP may transmit, to the UE, the first downlink data to which the phase compensation is applied at operation 2340.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which may access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
receiving, from each of at least one first transmission/reception point (TRP), a first channel state information reference signal (CSI-RS);
receiving, from a second TRP, a second CSI-RS;
estimating at least one first phase value of each of the first CSI-RS received from each of the at least one first TRP, based on the first CSI-RS received from each of the at least one first TRP;
estimating a second phase value based on the second CSI-RS; and
transmitting, to each of the at least one first TRP, a first sounding reference signal (SRS) and a second SRS on different adjacent symbols, respectively, based on a phase shift using the at least one first phase value and the second phase value.

2. The method of claim 1,
wherein the phase shift includes, on the second SRS, at least one phase difference value in which each of the at least one first phase value is subtracted from the second phase value, and
wherein the second SRS includes SRS to which each of the at least one phase difference is applied.

3. The method of claim 1,
wherein the phase shift includes the at least one first phase value and the second phase value,
wherein the first SRS includes SRS to which the second phase value is applied, and
wherein the second SRS includes SRS to which each of the at least one first phase value is applied.

4. The method of claim 1, further comprising:
receiving, from each of the at least one first TRP, a first downlink data; and
receiving, from the second TRP, a second downlink data,
wherein a phase compensation between each of the at least one first TRP and the second TRP using the first SRS and the second SRS transmitted based on the phase shift using the at least one first phase value and the second phase value is applied to each of the first downlink data received from each of the at least one first TRP.

5. The method of claim 1, further comprising:
receiving, from the at least one first TRP or the second TRP, configuration information including information on an SRS resource set associated with transmission of the first SRS and the second SRS,
wherein the information on the SRS resource set includes information indicating that the first SRS and the second SRS is transmitted for a phase compensation between each of the at least one first TRP and the second TRP and information on an SRS resource on which the first SRS and the second SRS is transmitted, and
wherein the information on the SRS resource includes information on an identifier (ID) on a CSI-RS resource on which the first CSI-RS of each of the at least one first TRP and the second CSI-RS of the second TRP are transmitted, and information on a unit of a number of resource block (RB) on a frequency domain which the phase shift is applied to the first SRS and the second SRS.

6. A method performed by a first transmission/reception point (TRP) in a wireless communication system, the method comprising:
transmitting, to a user equipment (UE), a first channel state information reference signal (CSI-RS);
receiving, from the UE, a first sounding reference signal (SRS) and a second SRS on different adjacent symbols, respectively, based on a phase shift using a first phase value of the first CSI-RS estimated based on the first CSI-RS and a second phase value of a second CSI-RS estimated based on the second CSI-RS of a second TRP;
applying a phase compensation between the first TRP and the second TRP using the first SRS and the second SRS received based on the phase shift using the first phase value and the second phase value to a first downlink data; and
transmitting, to the UE, the first downlink data to which the phase compensation is applied.

7. The method of claim 6,
wherein the phase shift includes, on the second SRS, a phase difference value in which the first phase value is subtracted from the second phase value, and
wherein the second SRS includes SRS to which the phase difference value is applied.

8. The method of claim 6,
wherein the phase shift includes the first phase value and the second phase value,
wherein the first SRS includes SRS to which the second phase value is applied, and
wherein the second SRS includes SRS to which the first phase value is applied.

9. The method of claim 6, further comprising:
calculating a phase difference value in which the first phase value is subtracted from the second phase value, based on the first SRS and the second SRS to which the phase shift is applied, wherein the phase difference value is an average value of phase difference values individually calculated on subcarriers to which the first SRS and the second SRS is mapped within a resource block (RB) on which the first SRS and the second SRS is transmitted; and
identifying a validity on the calculated phase difference value, based on a phase difference value used before a time on which the phase difference value is calculated and a pre-configured threshold value.

10. The method of claim 6, further comprising:
transmitting, to the UE, configuration information including information on an SRS resource set associated with transmission of the first SRS and the second SRS,
wherein the information on the SRS resource set includes information indicating that the first SRS and the second SRS is transmitted for a phase compensation between each of at least one first TRP and the second TRP and information on an SRS resource on which the first SRS and the second SRS is transmitted, and
wherein the information on the SRS resource includes information on an identifier (ID) on a CSI-RS resource on which the first CSI-RS of each of the at least one first TRP and the second CSI-RS of the second TRP are transmitted, and information on a unit of a number of resource block (RB) on a frequency domain which the phase shift is applied to the first SRS and the second SRS.

11. A user equipment (UE) in a wireless communication system, the UE comprising:
a transceiver; and
a controller coupled with the transceiver and configured to:
receive, from each of at least one first transmission/reception point (TRP), a first channel state information reference signal (CSI-RS),
receive, from a second TRP, a second CSI-RS,
estimate at least one first phase value of each of the first CSI-RS received from each of the at least one first TRP, based on the first CSI-RS received from each of the at least one first TRP,
estimate a second phase value based on the second CSI-RS, and
transmit, to each of the at least one first TRP, a first sounding reference signal (SRS) and a second SRS on different adjacent symbols, respectively, based on a phase shift using the at least one first phase value and the second phase value.

12. The UE of claim 11,
wherein the phase shift includes, on the second SRS, at least one phase difference value in which each of the at least one first phase value is subtracted from the second phase value, and
wherein the second SRS includes SRS to which each of the at least one phase difference is applied.

13. The UE of claim 11,
wherein the phase shift includes the at least one first phase value and the second phase value,
wherein the first SRS includes SRS to which the second phase value is applied, and
wherein the second SRS includes SRS to which each of the at least one first phase value is applied.

14. The UE of claim 11,
wherein the controller is further configured to:
receive, from each of the at least one first TRP, a first downlink data, and
receive, from the second TRP, a second downlink data, and
wherein a phase compensation between each of the at least one first TRP and the second TRP using the first SRS and the second SRS transmitted based on the phase shift using the at least one first phase value and the second phase value is applied to each of the first downlink data received from each of the at least one first TRP.

15. The UE of claim 11,
wherein the controller is further configured to:
receive, from the at least one first TRP or the second TRP, configuration information including information on an SRS resource set associated with transmission of the first SRS and the second SRS,
wherein the information on the SRS resource set includes information indicating that the first SRS and the second SRS is transmitted for a phase compensation between each of the at least one first TRP and the second TRP and information on an SRS resource on which the first SRS and the second SRS is transmitted, and
wherein the information on the SRS resource includes information on an identifier (ID) on a CSI-RS resource on which the first CSI-RS of each of the at least one first TRP and the second CSI-RS of the second TRP are transmitted, and information on a unit of a number of resource block (RB) on a frequency domain which the phase shift is applied to the first SRS and the second SRS.

16. A first transmission/reception point (TRP) in a wireless communication system, the first TRP comprising:
a transceiver; and
a controller coupled with the transceiver and configured to:
transmit, to a user equipment (UE), a first channel state information reference signal (CSI-RS),
receive, from the UE, a first sounding reference signal (SRS) and a second SRS on different adjacent symbols, respectively, based on a phase shift using a first phase value of the first CSI-RS estimated based on the first CSI-RS and a second phase value of a second CSI-RS estimated based on the second CSI-RS of a second TRP,
apply a phase compensation between the first TRP and the second TRP using the first SRS and the second SRS received based on the phase shift using the first phase value and the second phase value to a first downlink data, and
transmit, to the UE, the first downlink data to which the phase compensation is applied.

17. The first TRP of claim 16,
wherein the phase shift includes, on the second SRS, a phase difference value in which the first phase value is subtracted from the second phase value, and
wherein the second SRS includes SRS to which the phase difference value is applied.

18. The first TRP of claim 16,
wherein the phase shift includes the first phase value and the second phase value,
wherein the first SRS includes SRS to which the second phase value is applied, and
wherein the second SRS includes SRS to which the first phase value is applied.

19. The first TRP of claim 16, wherein the controller is further configured to:
calculate a phase difference value in which the first phase value is subtracted from the second phase value, based on the first SRS and the second SRS to which the phase shift is applied, wherein the phase difference value is an average value of phase difference values individually calculated on subcarriers to which the first SRS and the second SRS is mapped within a resource block (RB) on which the first SRS and the second SRS is transmitted; and
identify a validity on the calculated phase difference value, based on a phase difference value used before a time on which the phase difference value is calculated and a pre-configured threshold value.

20. The first TRP of claim 16,
wherein the controller is further configured to:
transmit, to the UE, configuration information including information on an SRS resource set associated with transmission of the first SRS and the second SRS,
wherein the information on the SRS resource set includes information indicating that the first SRS and the second SRS is transmitted for a phase compensation between each of at least one first TRP and the second TRP and information on an SRS resource on which the first SRS and the second SRS is transmitted, and
wherein the information on the SRS resource includes information on an identifier (ID) on a CSI-RS resource on which the first CSI-RS of each of the at least one first TRP and the second CSI-RS of the second TRP are transmitted, and information on a unit of a number of resource block (RB) on a frequency domain which the phase shift is applied to the first SRS and the second SRS.
